(19) United States
(12) Patent Application Publication
(10) Pub. No.: US 2015/0054803 A1
(43) Pub. Date: Feb. 26, 2015

(54) TOUCH PANEL WITH INTEGRATED COLOR FILTER

(71) Applicant: Sharp Kabushiki Kaisha, Osaka (JP)

(72) Inventors: Yuhji Yashiro, Osaka (JP); Hiroyuki Ogawa, Osaka (JP); Kazutoshi Kida, Osaka (JP); Yasuhiro Sugita, Osaka (JP)

(73) Assignee: SHARP KABUSHIKI KAISHA, Osaka (JP)

(21) Appl. No.: 14/394,803

(22) PCT Filed: Apr. 16, 2013
(86) PCT No.: PCT/JP2013/061243

§ 371 Date: Oct. 16, 2014

(30) Foreign Application Priority Data
Apr. 18, 2012 (JP) 2012-095105

(51) Int. Cl. G09G 3/36; G02F 1/1343; G02F 1/1333; G02F 1/1335; G06F 3/047; G06F 3/044

(52) U.S. Cl. CPC G09G 3/3648; G06F 3/047; G06F 3/044; G02F 1/13338; G02F 1/133512; G02F 1/133514; G02F 1/13439
USPC 345/206; 345/100

(57) ABSTRACT

Provided is a large surface area capacitive touch panel integrated with a color filter that can be applied to a large-screen display device. The color filter-integrated touch panel is constituted of mesh-shaped detection electrodes formed of a large number of meshes and mesh-shaped driving electrodes also formed of a large number of meshes in a first mesh layer. The driving electrodes include first driving electrodes formed in the first mesh layer and second driving electrodes formed in a second mesh layer, and the first driving electrodes and the second driving electrodes are electrically connected to each other. The second mesh layer, which is where the second driving electrodes are formed, is disposed between a display device that will be used after being combined and the first mesh layer in order to suppress the touch panel from being adversely affected by the display device.

### TECHNICAL FIELD

The present invention is directed to a touch panel, and more particularly, towards a color filter-integrated touch panel in which a color filter has been integrally formed with a touch panel for use in a liquid crystal display device or the like.

### BACKGROUND ART

Touch panels are becoming widespread for electronic devices such as mobile phones, car navigation systems, personal computers, and terminals or the like at banks, for example. A touch location (contact location) is inputted to these touch panels when a finger, pen tip, or the like makes contact with the touch panel while an image is shown on a display screen constituted of a liquid crystal display panel or the like. Various types of touch panels are being proposed based on detection principles for detecting touch location, but it is preferable to have a capacitive touch panel that has a simple mechanism and that can be made cheaply in a relatively large size. In particular, in-cell capacitive touch panels, which have the touch panel function embedded in the liquid crystal display device, have been gaining attention due to greatly contributing to lowering manufacturing costs and making devices thinner.

Patent Document 1 discloses a color filter-integrated touch panel in which touch location detecting electrodes are integrally provided with color filters in a liquid crystal display panel. FIG. 27 shows the basics of the color filter-integrated touch panel disclosed in Patent Document 1.

In FIG. 27, a black matrix is formed on a CF plate 5703, and an ITO1 layer 5701 for detecting touch location is formed on this CF plate 5703. An ITO2 layer 5702 is also formed on the CF plate 5703 through color filters and a planarizing layer. This ITO2 layer 5702 is used for applying common voltage during driving of an LCD device, and is used as a touch driving electrode when the LCD is not being driven.

The conventional example shown in FIG. 27 is a capacitive touch panel for detecting touch location and is formed in integration with the color filters on the color filter substrate, which makes it possible to realize a liquid crystal display device with a compact touch panel attached thereto. In other words, it is not necessary for the touch panel to be a separate component.

Patent Document 2 discloses a capacitive touch panel in which touch location detecting electrodes are disposed on the color filter substrate and formed in integration with the color filters, in a manner similar to Patent Document 1. FIG. 28 shows the basics of the color filter-integrated touch panel disclosed in Patent Document 2.

In FIG. 28, reference character 50 shows a touch panel-integrated color filter in which touch location detecting electrodes 60 and 70 have been formed in integration therewith. The touch panel-integrated color filter 50 includes a base material 52, a “color filter layer 54 having a plurality of colored portions 56” formed on the base material 52, and the electrode 60 disposed between the color filter layer 54 and the base material 52. The electrode 70 is disposed on the side of the electrode 60 opposite to the base material 52 through an insulating layer 67, and the electrodes 60 and 70 are electrically connected to a circuit for detecting touch location of a fingertip or the like on the display surface, which is on the viewer's side.

In a manner similar to the conventional example shown in FIG. 28, the conventional example shown in FIG. 27 is a touch panel for detecting touch location and is formed in integration with the color filters on the color filter substrate, which makes it possible to realize a liquid crystal display device with a compact touch panel attached thereto. In other words, it is not necessary for the touch panel to be a separate component.

Patent Document 2 also suggests that the touch location detecting electrodes 60 and 70 can be constituted of a metal layer patterned in a mesh shape or a metal film patterned in a stripe shape.

### RELATED ART DOCUMENTS

### Patent Documents

Patent Document 1: Japanese Translation of PCT International Application Publication No. 2009-540374 (Published Nov. 19, 2009)
Patent Document 2: Japanese Patent Application Laid-Open Publication No. 2010-72581 (Published Jul. 2, 2010)

### SUMMARY OF THE INVENTION

### Problems to be Solved by the Invention

According to the inventions disclosed in Patent Document 1 and Patent Document 2, it is possible to obtain a liquid crystal display device (in-cell capacitive touch panel) having a compact touch panel, in which the touch panel for touch location detection is formed in integration with color filters on the color filter substrate.

However, in the color filter-integrated touch panels (or touch panel-integrated color filter) in which the color filters and touch panel are integrated together in Patent Documents 1 and 2, there is no particular configuration to deal with problems occurring due to interaction among the electrodes forming the touch panel, the driving electrodes of the liquid crystal display device and the like, and the common driving electrode. Examples of these problems include touch panel malfunction due to noise during driving of the liquid crystal display device, and signal degradation due to coupling of the liquid crystal common electrode of the liquid crystal display device and the touch location detecting electrodes. As such, it is difficult to achieve a touch panel with stable operation using these configurations.

Furthermore, in the technology disclosed in Patent Document 1, when the surface area of touch panel is increased to a large size, the capacitive components of the circuit portion of the touch panel greatly increase, and the resistance of the transparent electrode such as ITO forming a portion of the touch panel also increases. These factors together cause the time constant of the circuits to increase and makes it difficult to realize a large surface area touch panel with a practical operating speed.

In other words, when a capacitive touch panel is integrated with a display device having a surface area that is larger than a mobile phone, tablet PC, and the like (when using an in-cell capacitive touch panel), it is not possible to attain a sufficient SN ratio for touch location detection due to being unable to achieve a sufficient integral network because of the increase of the RC time constant.

Patent Document 2 also suggests that, in order to lower capacitance, the detection electrodes and driving electrodes be made of a metal layer patterned in a mesh shape or a metal layer patterned in a stripe shape. As will be explained using FIG. 2 later, however, this causes signal degradation by coupling of the display driving circuits of the liquid crystal display device or the like and the detection electrodes and driving electrodes, which will all be used simultaneously. Therefore, in this case it is not possible to achieve sufficiently powerful enough detection signals.

Patent Document 2 describes a shield layer 75 being provided, but ordinarily, when a voltage is applied to the driving electrodes in a capacitive touch panel, an electric flux occurs from the driving electrodes to the detection electrodes, and this electric flux increases and decreases depending touch, thereby increasing and decreasing the capacitance between the driving electrodes and the detection electrodes and acting as a signal. Accordingly, when shielding electrodes are disposed directly below the driving electrodes, a large portion of the electric flux generated by the driving electrodes is absorbed by the shielding electrodes, and the electric flux ceases to contribute to the signal.

The present invention was made to solve the above-mentioned problems, and aims at providing a large-screen/large surface area touch panel that can be combined and use with various types of large display devices. The present invention further aims at providing a large-screen display device that has touch panel functionality and is easy to use.

### Means for Solving the Problems

To solve the above-mentioned problems, a color filter-integrated touch panel of the present invention includes: a substrate; a touch panel component having detection electrodes and driving electrodes for touch location detection disposed on the substrate; and a color filter formed on the touch panel component, the color filter making multicolor display possible after being combined with a display device, wherein the detection electrodes and the driving electrodes of the touch panel component are insulated from each other and are each mesh-shaped electrodes formed of a plurality of meshes, wherein the detection electrodes of the touch panel component are formed in a first mesh layer between the substrate and the color filter, wherein the driving electrodes are constituted of first driving electrodes formed in the first mesh layer and second driving electrodes formed in a second mesh layer that is between the first mesh layer and the color filter, and wherein at least a portion of the first driving electrodes and the second driving electrodes are formed in locations overlapping each other, the first driving electrodes and the second driving electrodes being connected to each other.

With this configuration, the detection electrodes and the driving electrodes for touch location detection on the touch panel component are all mesh electrodes constituted of a plurality of meshes; thus, it is possible to significantly reduce the capacitance of the circuits for touch location detection, which allows the touch panel to have a larger surface area.

Furthermore, the driving electrodes of the touch panel component are constituted of the first driving electrodes in the same first mesh layer as the detection electrodes, and the second driving electrodes that are disposed in a second mesh layer that is different from the first mesh layer and located close to the color filter, or namely, close to the display component that will be used after being assembled; therefore, the second driving electrodes can couple with the display component and the electrical coupling between the first driving electrodes and the display component can be alleviated, thereby making it possible to suppress a reduction in touch location detection signals.

To solve the above-mentioned programs, the color filter-integrated touch panel of the present invention includes a light-shielding member formed on the color filter that is adjacent to a viewing side, wherein the meshes of the detection electrodes and the driving electrodes forming the touch panel component are disposed at locations corresponding to the light-shielding member in a plan view.

With this configuration, the detection electrodes, driving electrodes, and floating electrodes are disposed corresponding to the location of the light-shielding member, which does not affect the display, in a plan view. Therefore, there is almost no reduction of display quality of the display device.

To solve the above-mentioned problems, in the color filter-integrated touch panel of the present invention, the light-shielding member is formed at respective edges of sub-pixels in a display device, and the meshes of the detection electrodes, the driving electrodes, and the floating electrodes forming the touch panel component are disposed at respective edges of the sub-pixels in the display device in a mesh shape.

With this configuration, the electrodes are disposed corresponding to the respective edges of the sub-pixels, which traditionally have almost no effect on display; thus, there will be very little reduction in display quality of the display device.

To solve the above-mentioned problems, in the color filter-integrated touch panel of the present invention, the detection electrodes and the driving electrodes of the touch panel component are made of a metal film.

With this configuration, the detection electrodes and driving electrodes forming the touch panel component are made of a metal film, thus allowing for the resistance of the circuit portions of the respective electrodes to be lowered and for suppression of an increase in the time constant of the circuits. This makes it possible for the touch panel to have a larger surface area. The detection electrodes and the first driving electrodes forming the touch panel component are formed in the same layer, and therefore, the formation of these electrodes can be done with one round of metal film deposition and patterning by photolithography, which makes the manufacturing thereof easier.

To solve the above-mentioned problems, in the color filter-integrated touch panel of the present invention, the detection electrodes are rectangular electrodes constituted of the plurality of meshes that extend in an X axis direction and a Y axis direction, a plurality of the detection electrodes being electrically connected in the Y axis direction, and wherein the first driving electrodes and the second driving electrodes forming the driving electrodes are rectangular electrodes constituted of the plurality of meshes that extend in the X axis direction and the Y axis direction, a plurality of the driving electrodes being electrically connected in the X axis direction.

With this configuration, the detection electrodes and the driving electrodes forming the touch panel component are constituted of meshes, which makes it possible to significantly reduce the capacitance of the circuits for touch location detection. This allows for the touch panel to have a larger surface area.

To solve the above-mentioned problems, in the color filter-integrated touch panel of the present invention, the detection electrodes are diamond-shaped electrodes constituted of the plurality of meshes that extend in an X axis direction and a Y axis direction, a plurality of the detection electrodes being electrically connected in the Y axis direction, and wherein the first driving electrodes and the second driving electrodes forming the driving electrodes are diamond-shaped electrodes constituted of the plurality of meshes that extend in the X axis direction and the Y axis direction, a plurality of the driving electrodes being electrically connected in the X axis direction.

With this configuration, the detection electrodes and the driving electrodes forming the touch panel component are constituted of meshes, which makes it possible to significantly reduce the capacitance of the circuits for touch location detection. This allows for the touch panel to have a larger surface area.

To solve the above-mentioned problems, the color filter-integrated touch panel of the present invention further includes: second driving electrodes and detection electrode metal bridges disposed in the second mesh layer, the detection electrode metal bridges connecting the detection electrodes to each other; and ground electrodes disposed in empty areas of the second mesh layer.

With this configuration, ground electrodes are disposed between the detection electrodes formed in the first mesh layer and the display component that will be used after being combined, thereby shielding the detection electrodes from the display component and making it possible to perform stable touch location detection.

To solve the above-mentioned problems, in the color filter-integrated touch panel of the present invention, the light-shielding member is formed on the substrate, and the touch panel component having the detection electrodes and the driving electrodes is formed on the light-shielding member.

With this configuration, in addition to being able to increase the surface area of the touch panel, the detection electrodes and driving electrodes formed in mesh-shapes are all formed under the light-shielding member as seen from the viewer's side. Thus, when the detection electrodes and the driving electrodes are formed of a good conductor such as metal, these electrodes become harder for the viewer to see, for example. Accordingly, when integrated with a display device, it is possible to prevent harming the display quality of the display device.

To solve the above-mentioned problems, a color filter-integrated touch panel of the present invention further includes: a display component formed on the touch panel component, wherein the touch panel component having the detection electrodes and the driving electrodes is formed on the substrate, and wherein the light-shielding member is formed at a location adjacent to the display component.

With this configuration, in addition to being able to obtain a touch panel that can have a large surface area, the distance between the detection electrodes and the display layer can be made greater by the light-shielding member being disposed between the second mesh layer and the color filter, or namely, the display device that will be used after being combined, which makes it possible to reduce the adverse effects of the display component on the detection electrodes.

To solve the above-mentioned problems, the color filter-integrated touch panel of the present invention further includes: detection electrode metal bridges and ground electrodes formed in the second mesh layer along with the second driving electrodes, the detection electrode metal bridges connecting the detection electrodes to each other, wherein the second driving electrodes, the detection electrode metal bridges, and the ground electrodes in the second mesh layer are insulated from each other and have gaps therebetween of one pitch or less, and wherein the second driving electrodes, the detection electrode metal bridges, and the ground electrodes have a light-shielding function.

With this configuration, in addition to being able to obtain a touch panel that can have a large surface area, even if the light-shielding member is omitted, the second driving electrodes, the detection electrode metal bridges, and the ground electrodes that have respective gaps therebetween (the areas where there are no electrodes) of one pitch or less have functions that are similar to the light-shielding member (black matrix), thereby making it possible to suppress visibility of the electrodes in the touch panel component. Accordingly, it is possible to reduce costs while preventing degradation of display characteristics of the display device.

To solve the above-mentioned problems, the color filter-integrated touch panel of the present invention further includes: a third mesh layer disposed between the second mesh layer and the color filter across insulating layers; and third driving electrodes disposed at a location where at least a portion thereof overlaps the first driving electrodes and the second driving electrodes, the third driving electrodes being electrically connected to the first driving electrodes and the second driving electrodes.

With this configuration, in addition to being able to obtain a touch panel that can have a large surface area, it is possible to more effectively suppress a reduction in touch location detection signals by further providing third driving electrodes as secondary driving electrodes that couple with the display device that will be use after being combined, thereby alleviating electrical coupling between the first driving electrodes and the display component.

To solve the above-mentioned problems, a liquid crystal display device according to the present invention fundamentally includes a color filter-integrated touch panel, having: a substrate; a touch panel component having detection electrodes and driving electrodes for touch location detection disposed on the substrate; and a color filter formed on the touch panel component, the color filter making multicolor display possible after being combined with a display device, wherein the detection electrodes and the driving electrodes of the touch panel component are insulated from each other and are each mesh-shaped electrodes formed of a plurality of meshes, wherein the detection electrodes of the touch panel component are formed in a first mesh layer between the substrate and the color filter, wherein the driving electrodes are constituted of first driving electrodes formed in the first mesh layer and second driving electrodes formed in a second mesh layer that is between the first mesh layer and the color filter, and wherein at least a portion of the first driving electrodes and the second driving electrodes are formed in locations overlapping each other, the first driving electrodes and the second driving electrodes being connected to each other.

With this configuration, it is possible to achieve a liquid crystal display device having a touch panel in which touch location can be detected on the entire surface of a large-sized display screen and in which a reduction in display quality has been minimized.

To solve the above-mentioned problems, a plasma display device according to the present invention fundamentally includes a color filter-integrated touch panel, having: a substrate; a touch panel component having detection electrodes and driving electrodes for touch location detection disposed on the substrate; and a color filter formed on the touch panel component, wherein the detection electrodes and the driving electrodes of the touch panel component are insulated from each other and are each mesh-shaped electrodes formed of a plurality of meshes, wherein the detection electrodes of the touch panel component are formed in a first mesh layer between the substrate and the color filter, wherein the driving electrodes are constituted of first driving electrodes formed in the first mesh layer and second driving electrodes formed in a second mesh layer that is between the first mesh layer and the color filter, and wherein at least a portion of the first driving electrodes and the second driving electrodes are formed in locations overlapping each other, the first driving electrodes and the second driving electrodes being connected to each other.

With this configuration, it is possible to achieve a plasma display device having a touch panel in which touch location can be detected on the entire surface of a large-sized display screen and in which a reduction in display quality has been minimized.

To solve the above-mentioned problems, an electroluminescent display device according to the present invention fundamentally includes a color filter-integrated touch panel, having: a substrate; a touch panel component having detection electrodes and driving electrodes for touch location detection disposed on the substrate; and a color filter formed on the touch panel component, wherein the detection electrodes and the driving electrodes of the touch panel component are insulated from each other and are each mesh-shaped electrodes formed of a plurality of meshes, wherein the detection electrodes of the touch panel component are formed in a first mesh layer between the substrate and the color filter, wherein the driving electrodes are constituted of first driving electrodes formed in the first mesh layer and second driving electrodes formed in a second mesh layer that is between the first mesh layer and the color filter, and wherein at least a portion of the first driving electrodes and the second driving electrodes are formed in locations overlapping each other, the first driving electrodes and the second driving electrodes being connected to each other.

With this configuration, it is possible to achieve an EL display device having a touch panel in which touch location can be detected on the entire surface of a large-sized display screen and in which a reduction in display quality has been minimized.

### Effects of the Invention

As described above, in one aspect, the present invention can provide a large-screen/large surface area display device having a highly convenient touch panel function in which it is possible to achieve a large-screen touch panel and with which the touch panel of the present invention and various types of large display devices are combined.

### BRIEF DESCRIPTION OF THE DRAWINGS

FIG. 1 is a view for explaining the fundamental configuration of a color filter-integrated touch panel according to the present invention.

FIG. 2 is a view for explaining the effects of the color filter-integrated touch panel of the present invention.

FIG. 3 is a view for explaining a cross-sectional configuration of a color filter-integrated touch panel according to Embodiment 1 of the present invention.

FIG. 4 is a view for explaining the schematic configuration of the detection electrodes and driving electrodes in the color filter-integrated touch panel according to Embodiment 1 of the present invention.

FIG. 5 is a view for explaining a configuration of one node portion of a first mesh layer and a second mesh layer in the color filter-integrated touch panel according to Embodiment 1 of the present invention.

FIG. 6 is a view for explaining the configuration of through-holes in the second mesh layer of the color filter-integrated touch panel according to Embodiment 1 of the present invention.

FIG. 7 is a view of one example of the size of the mesh electrodes that form the detection electrodes and the driving electrodes of the color filter-integrated touch panel according to Embodiment 1 of the present invention.

FIG. 8 is a view for explaining the configuration of the first mesh layer of the color filter-integrated touch panel according to Embodiment 1 of the present invention.

FIG. 9 is a view for explaining the configuration of the second mesh layer of the color filter-integrated touch panel according to Embodiment 1 of the present invention.

FIG. 10 is a view for explaining a method of manufacturing the color filter-integrated touch panel according to Embodiment 1 of the present invention.

FIG. 11 is a view showing simulation results of the color filter-integrated touch panel according to Embodiment 1 of the present invention.

FIG. 12 is a view for explaining a schematic structure of detection electrodes and driving electrodes in a color filter-integrated touch panel according to Embodiment 2 of the present invention.

FIG. 13 is a view for explaining a configuration of one node portion of a first mesh layer and a second mesh layer in the color filter-integrated touch panel according to Embodiment 2 of the present invention.

FIG. 14 is a view for explaining the configuration of the second mesh layer and through-holes in the color filter-integrated touch panel according to Embodiment 2 of the present invention.

FIG. 15 is a view of one example of the size of the mesh electrodes that form the detection electrodes and the driving electrodes of the color filter-integrated touch panel according to Embodiment 2 of the present invention.

FIG. 16 is a view for explaining the configuration of the first mesh layer in the color filter-integrated touch panel according to Embodiment 2 of the present invention.

FIG. 17 is a view for explaining the configuration of the second mesh layer in the color filter-integrated touch panel according to Embodiment 2 of the present invention.

FIG. 18 is a view for explaining a cross-sectional configuration of a color filter-integrated touch panel according to Embodiment 3 of the present invention.

FIG. 19 is a view of the general configuration of the electrodes in the color filter-integrated touch panel according to Embodiment 3 of the present invention.

FIG. 20 is a view for explaining a configuration of one node portion of a first mesh layer in the color filter-integrated touch panel according to Embodiment 3 of the present invention.

FIG. 21 is a view for explaining the configuration of the second mesh layer and through-holes in the color filter-integrated touch panel according to Embodiment 3 of the present invention.

FIG. 22 is a view of one example of the size of the mesh electrodes that form the detection electrodes, driving electrodes, and ground electrode of the color filter-integrated touch panel according to Embodiment 3 of the present invention.

FIG. 23 is a view for explaining the configuration of the first mesh layer in the color filter-integrated touch panel according to Embodiment 3 of the present invention.

FIG. 24 is a view for explaining the configuration of the second mesh layer in the color filter-integrated touch panel according to Embodiment 3 of the present invention.

FIG. 25 is a view for explaining a configuration of a color filter-integrated touch panel according to Embodiment 4 of the present invention.

FIG. 26 is a view for explaining a configuration of a color filter-integrated touch panel according to Embodiment 5 of the present invention.

FIG. 27 is a view for explaining a configuration of a conventional touch panel.

FIG. 28 is a view for explaining a configuration of a conventional touch panel.

### DETAILED DESCRIPTION OF EMBODIMENTS

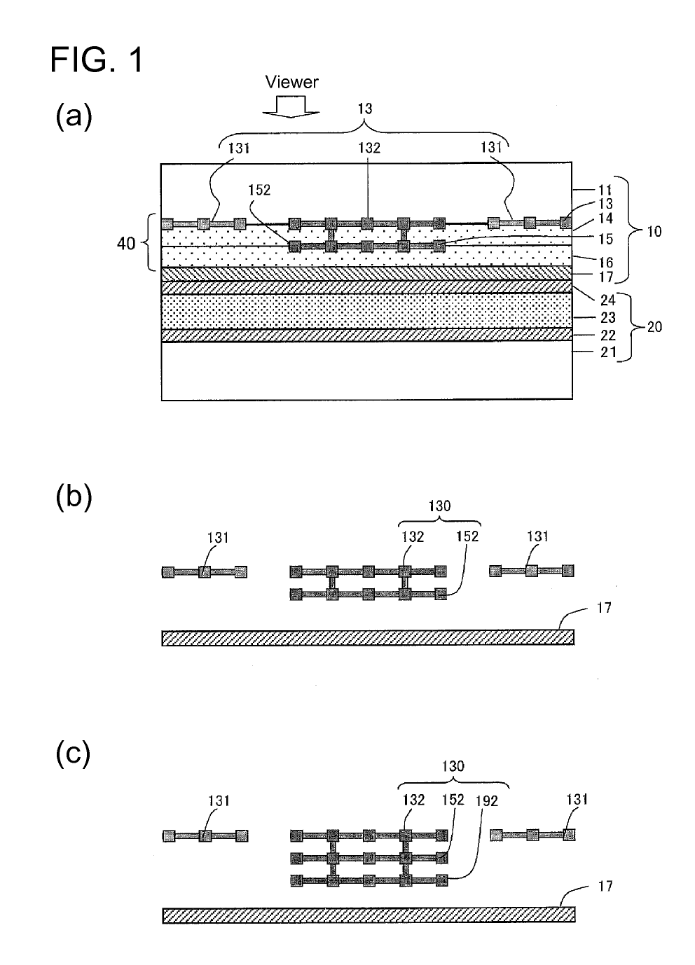

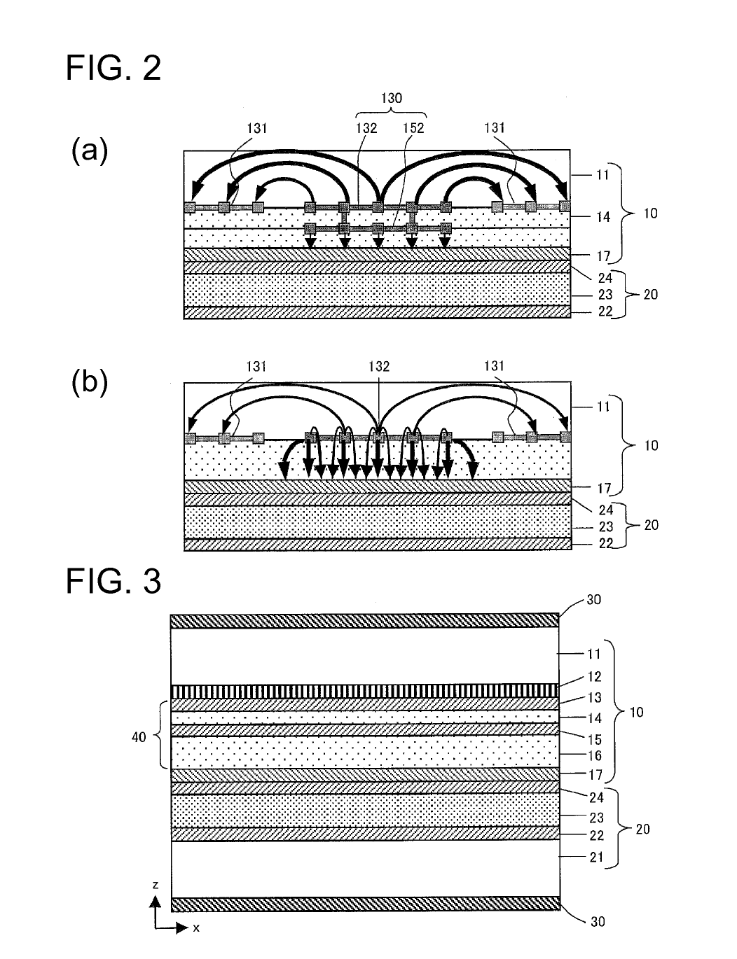

First, the fundamental configuration of the present invention will be explained using FIGS. 1 and 2, and then FIG. 3 onwards will be used to describe the embodiments of the present invention (Embodiment 1 to Embodiment 5) in detail. In the descriptions below, various limitations preferable for implementing the present invention are conferred, but the technical scope of the present invention is not limited by the disclosures of the embodiments and figures below. In the descriptions below, the same reference characters are given to identical members, and the description of these members will not be repeated. The figures are not drawn to scale, and the dimensions of part of a member may be expanded in the drawings for convenience of explanation.

(Fundamental Configuration of Present Invention)

FIGS. 1(a) and 1(b) are views of the fundamental configuration of the color filter-integrated touch panel according to the present invention. The color filter-integrated touch panel of the present invention is integrated with a liquid crystal display component to form a liquid crystal display device having a touch panel.

In FIG. 1(a), the reference character 10 is the color filter-integrated touch panel of the present invention, and reference character 20 is the liquid crystal display component that is combined with the color filter-integrated touch panel. The color filter-integrated touch panel 10 and the liquid crystal display component 20 constitute a liquid crystal display device having a touch panel attached thereto.

As shown in FIG. 1(a), the color filter-integrated touch panel 10 includes a color filter glass substrate 11, a first mesh layer 13, a first insulating layer 14, a second mesh layer 15, a second insulating layer 16, and a color filter 17. These are formed on the color filter glass substrate 11 in the above order. In other words, the first mesh layer 13 is disposed between the color filter glass substrate (also called the “substrate”) 11 and the color filter 17, and the second mesh layer 15 is disposed between the first mesh layer 13 and the color filter 17.

Detection electrodes 131 and first driving electrodes 132 are insulated from each other in the first mesh layer, and second driving electrodes 152 are formed in the second mesh layer 15. The first driving electrodes 132 and the second driving electrodes 152 are electrically connected to each other, and as shown in FIG. 1(b), driving electrodes 130 are constituted of the first driving electrodes 132 and the second driving electrodes 152.

The detection electrodes 131, the first driving electrodes 132, and the second driving electrodes 152 are all mesh electrodes constituted of a plurality of meshes, and are preferably made from a metal film with high conductivity. A detailed configuration for these electrodes will be explained later using FIG. 3 onward.

The first driving electrodes 132 and the second driving electrodes 152 face each other through the first insulating layer 14, or namely, are formed overlapping each other as seen from the viewer's side of the display device (the top of the substrate 11 in the drawing). These electrodes are electrically connected to each other by through-holes. A capacitive touch panel component 40 for touch location detection is formed by the detection electrodes 131 and the driving electrodes 130 that are constituted of the first driving electrodes 132 and the second driving electrodes 152.

Ordinarily, when a voltage is applied to the driving electrodes in a capacitive touch panel, an electric flux occurs from the driving electrodes to the detection electrodes, and this electric flux increases and decreases depending on touch, thereby increasing and decreasing the capacitance between the driving electrodes and the detection electrodes and acting as a signal. Namely, when a fingertip or the like touches a specific location on the color filter glass substrate 11 (the top in the drawing), the detection electrodes 131 detect a change in capacitance between the detection electrodes 131 and the driving electrodes 130, and a specific touch location is detected.

These mechanisms are already known and will not be explained in detail. The color filter-integrated touch panel is constituted of the touch panel component 40 and the color filter 17. The viewer views the liquid crystal display device from the top of the color filter substrate 11 (the top in the drawing).

Reference character 20 is the liquid crystal display component, which has a glass substrate 21, a liquid crystal driving electrode 22 formed on this glass substrate 21, a liquid crystal common electrode 24 having a prescribed space (gap) being between the liquid crystal driving electrode 22 and this liquid crystal common electrode 24, and a liquid crystal layer 23 filled into this gap between the liquid crystal driving electrode 22 and the liquid crystal common electrode 24. The liquid crystal common electrode 24 is formed on the color filter 17 on the color filter substrate 11 side. The color filter-integrated touch panel 10 and the liquid crystal display component 20 combine to form a touch panel-integrated liquid crystal display device.

If shielding electrodes are disposed directly below the driving electrodes, a large portion of the electric flux generated by the driving electrodes is absorbed by the shielding electrodes, and the electric flux ceases to contribute to the signal. As explained later with reference to FIG. 2, however, the presence of the second driving electrodes 152 reduces the electric flux drawn in by the liquid crystal common electrode 24 from the first driving electrodes 132, thus making it possible to maintain a strong signal strength from the first driving electrodes 132.

In order to achieve multi-color display on the liquid crystal display component side, the color filter 17 ordinarily has color filters, each having one of the primary colors (RGB), with the color differing for each sub-pixel in every pixel. These configurations are already known, and thus will not be described in detail. A detailed configuration thereof is also not disclosed in FIG. 1. In summary, the color filter 17 is included in display devices such as liquid crystal display devices and makes it possible for the display device to perform multi-color display.

FIG. 1(b) is a view for clarifying the relationship between the detection electrodes 131 and the driving electrodes 130. As already described, the detection electrodes 131 and the first driving electrodes 132 are insulated from each other in the first mesh layer 13, and the second driving electrodes 152 are formed in the second mesh layer 15. The first driving electrodes 132 and the second driving electrodes 152 are electrically connected to each other and operate as the driving electrodes 130. As already described, the second driving electrodes 152 are inserted between the first driving electrodes 132 and the color filter 17.

The first driving electrodes 132 and the second driving electrodes 152 are mesh-shaped electrodes constituted of a plurality of meshes, as already described, and the individual meshes are stacked so as to conform with each other in the vertical direction in the drawing. In FIGS. 1(a) and 1(b), the first driving electrodes 132 and the second driving electrodes 152 are shown as mesh-shaped electrodes having the same size (surface area) and the same meshes, but the present invention is not limited to this. In other words, the size (surface area) of the electrodes of the first driving electrodes 132 and the second driving electrodes 152 may have shapes that do not exactly conform to each other, as long as the second driving electrodes 152 do not overlap the detection electrodes 131. A more standardized configuration would be the first driving electrodes 132 and the second driving electrodes 152 having at least a portion overlapping each other.

In FIGS. 1(a) and 1(b), the driving electrodes 130 are shown as a two-layer structure of the first driving electrodes 132 and the second driving electrodes 152, but a configuration of three or more layers may be used in which a third mesh layer and a fourth mesh layer are provided between the second driving electrodes 152 and the color filter 17 and then third driving electrodes, fourth driving electrodes, and the like are disposed in the respective mesh layers.

FIG. 1(c) shows an example in which third driving electrodes 192 are provided. A third mesh layer is disposed between the second driving electrodes 152 and the color filter 17 across insulating layers, and the third driving electrodes 192 are disposed in this third mesh layer.

The first driving electrodes 132 function as primary electrodes for detecting changes in capacitance between the detection electrodes 131. As explained later, the second driving electrodes 152 performs coupling with the liquid crystal common electrode of the liquid crystal display device 20, and if the first driving electrodes function as the primary driving electrodes, then the second driving electrodes function as so-called secondary driving electrodes. When the driving electrodes 130 are formed of three or more layers of driving electrodes, the second driving electrodes 152 and the third driving electrodes 192 that function as similar secondary driving electrodes, fourth driving electrodes, and so on are formed with respect to the first driving electrodes 132 that function as primary driving electrodes. In general, the more layers there are, the smaller the coupling will be between the first driving electrodes and the liquid crystal common electrode; therefore, this improves detection sensitivity. Manufacturing costs, however, will increase the more layers there are, and therefore the number of layers should be determined in accordance with the desired sensitivity.

The first driving electrodes, the second driving electrodes, the third driving electrodes, and the like do not need to have the same shape, and at least a portion thereof may be formed in overlapping locations. More specifically, the second driving electrodes may be formed in a location that overlaps the first driving electrodes as long as there is no overlap with the detection electrodes in a plan view, for example. The first driving electrodes, second driving electrodes, third driving electrodes, and the like are electrically connected.

Next, the effects of the color filter-integrated touch panel according to the present invention will be explained using FIG. 2. FIG. 2(a) shows distribution of lines of electric force when a driving voltage is applied to the driving electrodes 130 in a liquid crystal display device having the color filter-integrated touch panel of the present invention. FIG. 2(b) also shows the distribution of lines of electric force when a driving voltage is applied to driving electrodes 132 in a liquid crystal display device having a conventional color filter-integrated touch panel. In the color filter-integrated touch panel according to the present invention shown in FIG. 2(a), an example is shown in which the driving electrodes 130 are constituted of the first driving electrodes 132 and one second driving electrode, or namely, the second driving electrodes 152.

In the color filter-integrated touch panel of the present invention, the detection electrodes 131 and the driving electrodes 130 are all formed as a mesh-shaped electrode constituted of a plurality of meshes. Therefore, it is possible to avoid a large increase in capacitor components based on the detection electrodes 131 and the driving electrodes 130 of the touch panel, which allows for the touch panel to have a larger surface area. However, a metal film having excellent conductivity is used as the material of the mesh-shaped electrode in accordance with the surface area of the touch panel, due to a large surface area touch panel causing an increase in resistance because of the enlargement of the driving electrodes and the mesh shape of the electrode.

In the liquid crystal display device having the conventional color filter-integrated touch panel, if a driving voltage is applied between the detection electrodes 131 and driving electrodes 132′, then as shown in FIG. 2(b), a portion of the lines of electric force from the driving electrodes 132′ reaches the detection electrode 131 side, but most of the lines of electric force go through the meshes of the driving electrodes 132′ and escape towards the liquid crystal common electrode 24. In liquid crystal display devices having the capacitive touch panel formed in integration therewith (in-cell capacitive touch panel), the driving electrodes 132′ of the touch panel and the common electrode 24 of the liquid crystal display device are arranged physically close to each other, which increases the coupling effect between the driving electrodes of the touch panel and the liquid crystal common electrode of the liquid crystal display device.

As shown in FIG. 2(a), in the liquid crystal display device having the color filter-integrated touch panel of the present invention, the driving electrodes 130 are constituted of the first driving electrodes 132 and the second driving electrodes 152 that are formed across the first insulating film 14. The first driving electrodes 132 and the second driving electrodes 152 are electrically connected by through-holes formed in the first insulating film 14 between the first driving electrodes and the second driving electrodes. When a driving voltage is applied to the driving electrodes 130, the second driving electrodes 152 couple with the liquid crystal common electrode 24, which makes it possible to increase the amount of electric flux from the first driving electrodes 132 to the touch surface, or namely, the substrate 11 side. This enables the signal strength for touch location detection to be improved.

This means that a touch location detection of a sufficient sensitivity can be obtained even if detection electrodes and driving electrodes having a mesh shape and reduced capacitor components are used; therefore, it is possible to realize a touch panel that allows for an increase in surface area. In particular, when a metal film having excellent conductivity is used for the detection electrodes and driving electrodes, it is possible to suppress an increase in resistance of the electrodes and to obtain a touch panel having a larger surface area.

In summary, to solve the above-mentioned problems, a color filter-integrated touch panel of the present invention includes a color filter-integrated touch panel, having: a substrate; a touch panel component having detection electrodes and driving electrodes for touch location detection disposed on the substrate; and a color filter formed on the touch panel component, wherein the detection electrodes and the driving electrodes of the touch panel component are insulated from each other and are each mesh-shaped electrodes formed of a plurality of meshes, wherein the detection electrodes of the touch panel component are formed in a first mesh layer between the substrate and the color filter, wherein the driving electrodes are constituted of first driving electrodes formed in the first mesh layer and second driving electrodes formed in a second mesh layer that is between the first mesh layer and the color filter, and wherein at least a portion of the first driving electrodes and the second driving electrodes are formed in locations overlapping each other, the first driving electrodes and the second driving electrodes being connected to each other.

In Embodiment 1 to Embodiment 5 below, which relate to the color filter-integrated touch panel of the present invention, the driving electrodes have a two-layer structure constituted of first driving electrodes and second driving electrodes, but as was explained with reference to FIG. 1(c), it is possible to have third driving electrodes and a driving electrode structure that is three or more layers.

### Embodiment 1

FIGS. 3 to 9 show Embodiment 1 related to a color filter-integrated touch panel of the present invention. In FIGS. 3 to 9, members that are the same as in FIG. 1 are given the same reference characters, and a detailed description of these members will not be repeated. In the embodiment described below, an example is described in which driving electrodes 130 are constituted of first driving electrodes and second driving electrodes.

FIG. 3 is a view of the cross-sectional structure of the color filter-integrated touch panel of Embodiment 1 and shows a liquid crystal display device in which a color filter-integrated touch panel 10 according to Embodiment 1 of the present invention has been integrated with a liquid crystal display component 20.

In FIG. 3, the color filter-integrated touch panel 10 has a substantially similar configuration to that described in FIG. 1(a), but in this configuration a light-shielding member 12, called a “black matrix,” is ordinarily formed on a color filter glass substrate 11. A touch panel component 40 is formed on this light-shielding member 12. In order to function as a liquid crystal display device, polarizing plates 30 are respectively disposed on the bottom of the liquid crystal display component 20 in the drawing and the top of the color filter-integrated touch panel 10 in the drawing. The coordinate axes X and Z in FIG. 3 show the horizontal direction and the thickness direction of the liquid crystal display device, respectively.

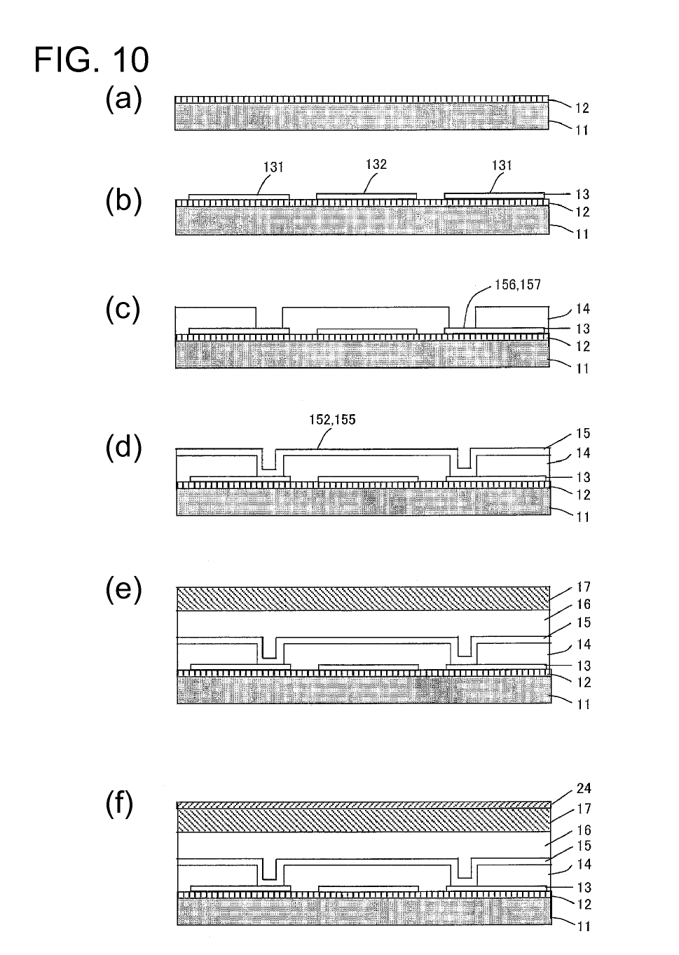

As explained later with reference to FIG. 10, in the manufacturing of the liquid crystal display device, in practice a liquid crystal common electrode 24 of the liquid crystal display component 20 is formed on the color filter glass substrate 11 side, and liquid crystal is filled into a gap between this substrate and a glass substrate 21 on which a liquid crystal driving electrode 22 is formed, thereby forming a liquid crystal layer 23.

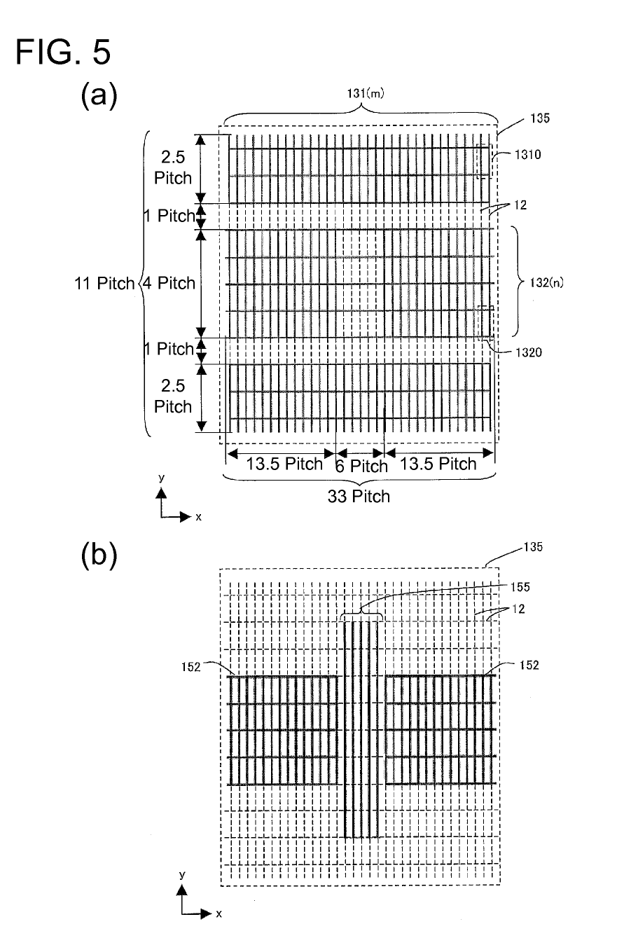

In FIG. 3, reference character 10 is the color filter-integrated touch panel, which includes the touch panel component 40 and a color filter 17. The touch panel component 40 is a so-called in-cell capacitive touch panel, and has a first mesh layer 13, a first insulating layer 14, a second mesh layer 15, and a second insulating layer 16. Detection electrodes 131 and first driving electrodes 132, which are described in detail using FIGS. 5(a), 6, 7, and 8, are formed in the first mesh layer 13. Second driving electrodes 152 and detection electrode metal bridges 155, which are described in detail using FIGS. 5(b), 6, and 9, are formed in the second mesh layer 15.

As already described, in the color filter-integrated touch panel of Embodiment 1 shown in FIG. 3, the light-shielding member 12 is formed on the color filter substrate 11. In other words, the touch panel component 10 including the detection electrodes 131 and the first driving electrodes 132 is formed under the light-shielding member 12 as seen from the side where the display device is viewed (the viewer's side).

In Embodiment 1, the detection electrodes 131 and the first driving electrodes 132 are all formed of a 0.2 μm metal film in the first mesh layer 13, and the second driving electrodes 152 and the detection electrode metal bridges 155 are formed of a 0.2 μm metal film in the second mesh layer 15. A Ti film, a three-layer film of Ti/Al/Ti, a two-layer film of Mo/Al, or the like can be used as the metal film, for example. The thickness of the first insulating layer 14 is 2 μm and the thickness of the second insulating layer 16 is 4 μm. The reason the second insulating layer 16 is made thicker than the first insulating layer is to separate the liquid crystal common electrode 24 from the other electrodes (the detection electrodes 131, the first driving electrodes 132, and the second driving electrodes 152) in order to minimize coupling with the liquid crystal common electrode 24.

Reference character 20 is the liquid crystal display component, which will be combined with the color filter-integrated touch panel 10 and used. The liquid crystal display component 20 includes a glass substrate 21, a liquid crystal driving electrode 22, the liquid crystal common electrode 24, and a liquid crystal layer 23 filled into the space (gap) between the liquid crystal driving electrode and the liquid crystal common electrode. 30 and 30 are polarizing plates. The liquid crystal display device having the touch panel formed in integration therewith is constituted of the color filter-integrated touch panel 10 that includes the color filter 17, the liquid crystal display component 20, and the two polarizing plates 30 and 30.

In Embodiment 1 shown in FIG. 3, the liquid crystal display component 20 is shown, but a plasma display component (a plasma display device without the color filter), a white light-emitting EL display component (an EL display device without the color filter in which it is possible to perform color display by disposing a color filter on the white light-emitting EL panel), or the like can be used instead.

Providing the color filter 17 and the light-shielding member 12 are well-known techniques and a detailed description thereof will be omitted. In Embodiment 1, however, the color filter 17 has color filters with the three primary colors, RGB, in respective sub-pixels of the pixels in the liquid crystal display device 20, and the light-shielding member 12 is ordinarily formed at the respective edges of these sub-pixels. The present invention is not limited to this, and more generally speaking, the light-shielding member (or the black matrix) 12 does not necessarily need to be formed at all of the respective edges of the sub-pixels, and may be formed on the color filter in a position close to the viewing side and function as a light-shielding member that shields unnecessary light and the like from the display device. In addition to a display device using the three primary colors, RGB, a display device that uses four colors, such as RGBW, which has W (white) or the like added can be used, but a detailed explanation thereof will be omitted.

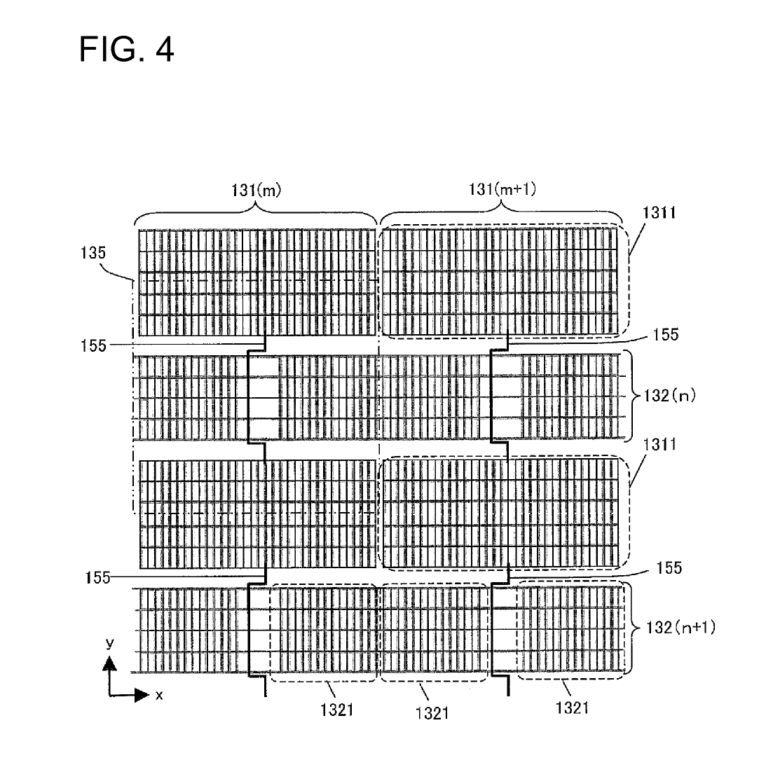

FIG. 4 shows details of the first mesh layer 13. A plurality of the detection electrodes 131(m) and 131(m+1) extending in the Y axis direction and a plurality of the first driving electrodes 132(n) and 132(n+1) extending in the X axis direction are formed in the first mesh layer 13. Needless to say, the plurality of the detection electrodes 131(m) and 131(m+1) are insulated from each other, and in a similar manner, the plurality of the first driving electrodes 132(n) and 132(n+1) are insulated from each other. In the descriptions below, unless stated otherwise, the plurality of detection electrodes 131(m) and 131(m+1) are referred to as simply “the detection electrodes 131,” and in a similar manner, the plurality of first driving electrodes 132(n) and 132(n+1) are referred to as simply “the first driving electrodes 132.”

In Embodiment 1 shown in FIG. 4, the first driving electrodes 132 are electrically connected in the first mesh layer 13 in the X axis direction, and the detection electrodes 131 are electrically connected in the Y axis direction by the detection electrode metal bridges 155, described later, in the second mesh layer 15. The detection electrodes 131 and the first driving electrodes 132 are all mesh-shaped electrodes constituted of a plurality of meshes, and the plurality of meshes are formed at the respective edges of the sub-pixels in the liquid crystal display component 20, which will be used after being combined. Accordingly, this results in the meshes being formed at the respective edges of the sub-pixels in the liquid crystal display component 20, in a manner similar to the light-shielding member 12.

In FIG. 4, the reference character 135 is the area assumed to be the smallest unit for touch location detection of the touch panel, and in the present invention this area is referred to as “one node area.”

In FIG. 5(a), the one node area 135 has been enlarged to show a more detailed configuration of the detection electrodes 131(m) and the first driving electrodes 132(n) formed in the first mesh layer 13. In FIG. 5(a), the length of one mesh (length of one unit) forming a portion of the electrodes is described as “one pitch.” Although not shown in FIG. 4, in FIG. 5(a) the reference character 12 is the light-shielding member (which has the same function as a black matrix), and as shown in FIG. 5(a), the light-shielding member is formed in a mesh shape having a plurality of meshes. As already explained, this light-shielding member 12 is ordinarily formed at the respective edges of the sub-pixels in the display device, which will be used after being combined.

As shown in FIG. 5(a), the detection electrodes 131 and the first driving electrodes 132 of the one node area 135 are formed at a pitch of 33 in the X axis direction and a pitch of 11 in the Y axis direction. The pitch in the X axis direction and the Y axis direction are different from each other, but in Embodiment 1, as shown in FIG. 7, the dimensions in the X axis direction and Y axis direction of a single mesh are made to be different, and the one node area 135 in its entirety is designed to be a 5.610 mm quadrilateral shape.

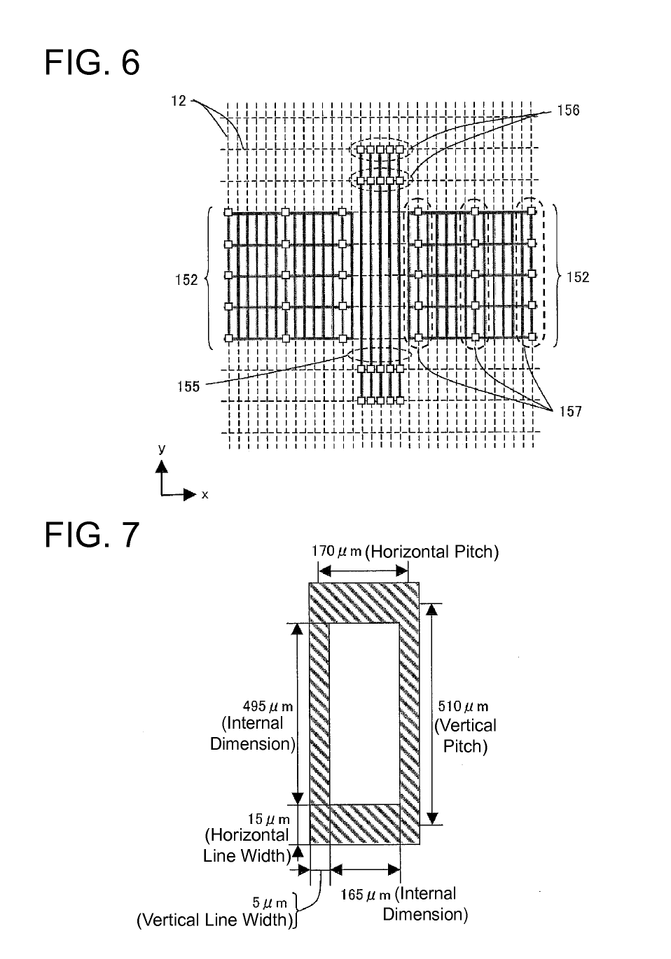

The detection electrodes 131 in the one node area 135 are constituted of two areas divided along both edges in the Y axis direction, with one area being formed at a pitch of 32 along the X axis direction and the other area being formed at a pitch of 2.5 along the Y axis direction. The first detection electrodes 131 are electrically connected to each other by the detection electrode metal bridges 155 formed in the second mesh layer 15. The configuration of the detection electrode metal bridges 155 will be described in detail later using FIGS. 5(b) and 6.

The first driving electrodes 132 have a width at a pitch of 4 in the Y axis direction and cut across the center portion of the detection electrodes 131 in the X axis direction. In the one node area 135, the first driving electrodes 132 have a “non-mesh portion” at a pitch of 6 in the X axis direction, and two areas of the first driving electrodes 132 are respectively formed in the X axis direction at pitches of 13.5. These areas are electrically connected in the X axis direction.

As shown in FIGS. 4 and 5, in Embodiment 1 the detection electrodes 131 are constituted of a plurality of rectangular electrodes 1311 (see FIG. 4), which are themselves constituted of a plurality of meshes 1310 (see FIG. 5) extending in the X axis direction and the Y axis direction. The rectangular electrodes 1311 are electrically connected in the Y axis direction. The first driving electrodes 132 are constituted of a plurality of rectangular electrodes 1321 (see FIG. 4), which are themselves constituted of a plurality of meshes 1320 (see FIG. 15) extending in the X axis direction and the Y axis direction. The first driving electrodes 132 are electrically connected in the X axis direction.

A specific design example of one of the meshes 1310 forming the detection electrodes 131 and one of the meshes 1320 forming the first driving electrodes 132 is shown in FIG. 7. The mesh 1310 and the mesh 1320 are designed with the same size. As shown in FIG. 5(b), a single mesh electrode has a vertical line width (line width in the Y axis direction) of 5 μm, a horizontal line width (line width in the X axis direction) of 15 μm, a vertical pitch (in the Y axis direction) of 510 μm, and internal dimensions of 165μ×495 μm. These values correspond to one design example, and the present invention is not limited to these values, but as described later, it is confirmed that a touch panel with a large surface area can be formed if these values are followed.

The details of the second driving electrodes 152 and the detection electrode metal bridges 155 formed in the second mesh layer 15 are shown in FIG. 5(b). FIG. 5(b) is a one node area that is the same as the one node area 135 in FIG. 5(a). The layer that is formed is different from the first mesh layer 13 and the second mesh layer 15, but overlaps the same portions in a plan view (as seen from the viewer's side when assembled as a display device).

In the example shown in FIG. 5(b), the detection electrode metal bridges 155 are constituted of five metal wiring lines and electrically connect the detection electrodes 131 that are divided into the two areas shown in FIG. 5(a) by contact holes 156, which are shown in detail in FIG. 6.

The second driving electrodes 152 are divided into two areas by the detection electrode metal bridges 155, but the meshes of the second driving electrodes 152 are formed at the respective edges of the light-shielding member 12. Accordingly, these meshes overlap the same portions as the meshes of the first driving electrodes 132 in a plan view (as seen from the viewer's side when assembled as a display device). The second driving electrodes 152 are electrically connected by a plurality of contact holes 157 shown in FIG. 6 to the first driving electrodes 132 formed in the first mesh layer 13. The first driving electrodes 132 are electrically connected in the X axis direction, and thus, the second driving electrodes 152 are also connected in the X axis direction.

In FIG. 6, the contact holes for connecting the detection electrodes 131 are collectively referred to as the contact holes 156, but in practice there are twenty contact holes in total for connecting the detection electrode metal bridges 155 and the detection electrodes 131. The contact holes for connecting the first driving electrodes 132 and the second driving electrodes 152 are also collectively referred to as the contact holes 157, but in practice there are thirty of these contact holes. The location, number, and the like of the contact holes 156 for connecting the detection electrodes and the contact holes 157 for connecting the first driving electrodes 132 and the second driving electrodes 152 shown in FIG. 6 are all one example, and the present invention is not limited to what is shown in the drawing. In FIG. 6, for ease of viewing, the reference characters 156 and 157 have only been given to the upper-half and right-half of the contact holes, respectively. The light-shielding member 12 is also shown by dashed lines in FIG. 6.

It is preferable that a metal film be used for the detection electrode metal bridges 155, due to conductivity, but it is also possible to use a transparent conductive film such as ITO, depending on the size of the touch panel. It is also possible to use a carbon-based conductive material (carbon nanotubes, graphene, or the like).

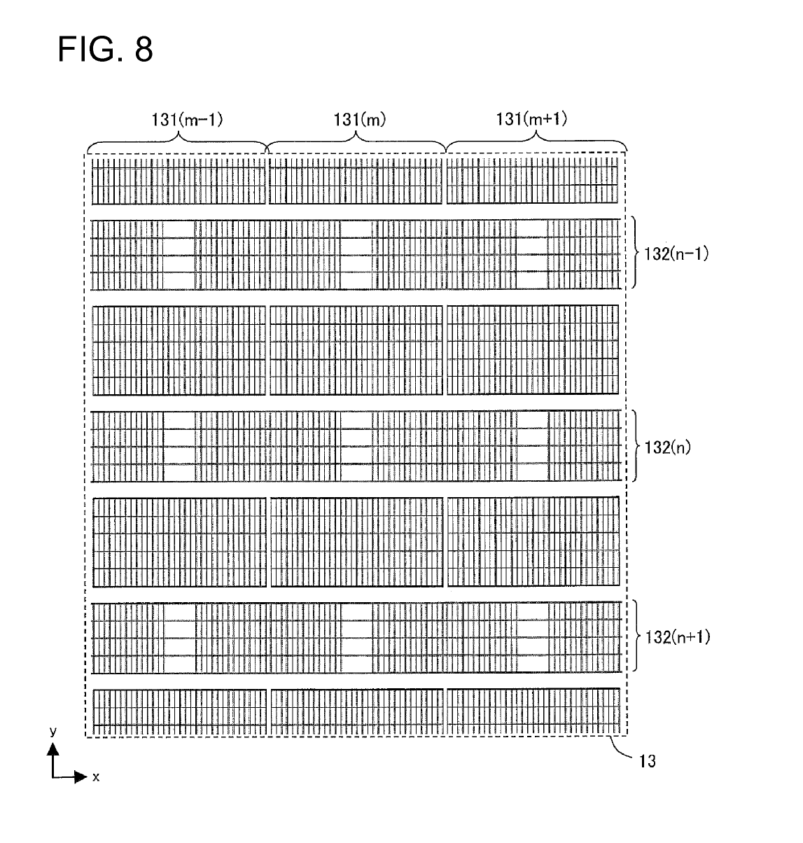

FIG. 8 shows a more practical configuration of the detection electrodes 131 and the first driving electrodes 132 formed in the first mesh layer 13. Namely, FIG. 8 shows three rows of detection electrodes 131(m−1), 131(m), and 131(m+1) connected in the Y axis direction and three rows of first driving electrodes 132(n−1), 132(m), and 132(m+1) connected in the X axis direction.

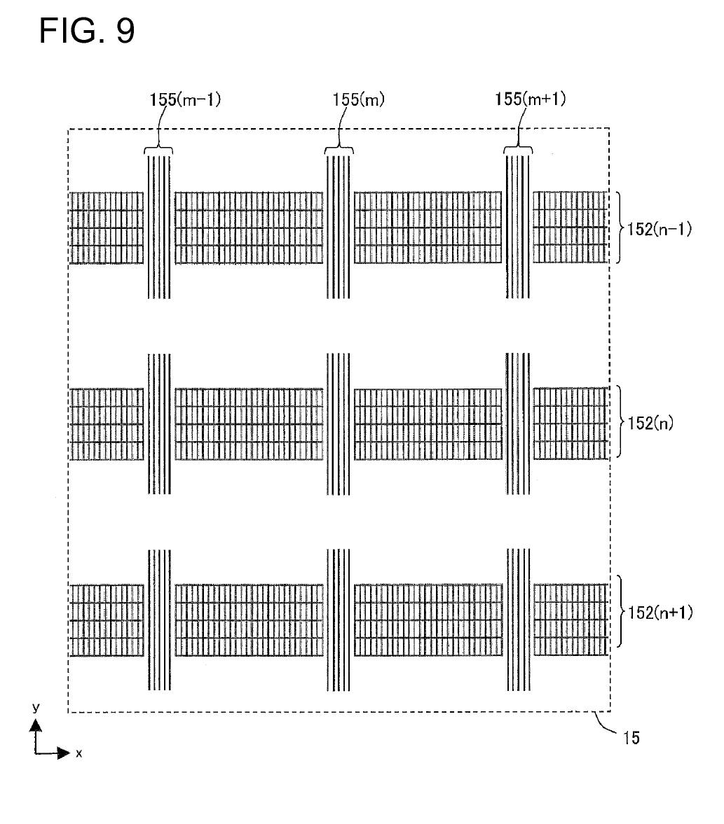

FIG. 9 shows a more practical configuration of the second driving electrodes 152 and the detection electrode metal bridges 155 formed in the second mesh layer 15. Namely, FIG. 9 shows three rows of detection electrode metal bridges 155(m−1), 155(m), and 155(m+1) extending in the Y axis direction and three rows of second driving electrodes 152(n−1), 152(n), and 152(n+1) extending in the X axis direction. As already described, the detection electrode metal bridges 155 connect the detection electrodes 131 in the Y axis direction via the contact holes 156 (see FIG. 6), and the second driving electrodes 152 are electrically connected to the first driving electrodes 132 via the contact holes 157 (see FIG. 6).

The detection electrode metal bridges 155 and the second driving electrodes 152 can be made of the same metal film. In this case, the second driving electrodes 152 and the detection electrode metal bridges 155, which are required to have high conductivity, can be formed by one round of metal film deposition and then patterning through photolithography. This makes the manufacturing process easier.

As already described above, in the color filter-integrated touch panel according to Embodiment 1, the meshes of the detection electrodes 131, the meshes of the first driving electrodes 132, the meshes of the second driving electrodes 152, and the detection electrode metal bridges 155 are all formed at respective edges in sub-pixels of each pixel in a display device where all of these meshes are combined and used. These are members that traditionally have few effects on display quality of the display device, and ordinarily a light-shielding member (black matrix) is formed at the respective edges of these sub-pixels. Accordingly, it is possible to suppress adverse effects on the display quality of the display device even if the detection electrodes 131, the first driving electrodes 132, the second driving electrodes 152, and the detection electrode metal bridges 155 are made of a metal film with high conductivity. A Ti film, a three-layer film of Ti/Al/Ti, a two-layer film of Mo/Al, or the like can be used as the metal film, for example.

In conventional touch panels that use a transparent electrode such as ITO instead of detection electrodes, first driving electrodes, and second driving electrodes, the limit for the touch panel size is approximately 11 inches, but with the configuration of the present invention, this size can be substantially increased. It is predicted that the size of the touch panel can be increased to approximately 42 inches by lowering resistance and capacitance with the detection electrodes and the first driving electrodes being meshes made of a metal film, lowering the capacitance, and suppressing signal degradation by providing the second driving electrodes made of a metal film, for example.

In the color filter-integrated touch panel of Embodiment 1 shown in FIG. 3, the light-shielding member 12 is provided at a location closer to the viewer than the touch panel component 40. Therefore, in the color filter-integrated touch panel in Embodiment 1, the presence of the detection electrodes 131 and the first driving electrodes 132 will not be noticed by the viewer even if the detection electrodes 131 and the first driving electrodes 132 are made of a metal film, and display quality will also not be reduced by this configuration.

In the examples shown in FIGS. 4 to 9, it is described that “the meshes of the detection electrodes 131, the meshes of the first driving electrodes 132, and the meshes of the second driving electrodes 152 are formed at the respective edges of the sub-pixels in the display device, which will be used after being combined,” but the present invention is not necessarily limited to this. In the case of an ultra-high resolution display device in which the sub-pixel size is very small, for example, the meshes of the detection electrodes 131, the meshes of the first driving electrodes 132, and the meshes of the second driving electrodes may be formed at the respective edges of the sub-pixels. The meshes of the detection electrodes 131, the meshes of the first driving electrodes 132, and the meshes of the second driving electrodes 152 do not all have to be the same size, and the meshes of the second driving electrodes 152 may be made bigger or smaller, for example.

In Embodiment 1 described above, the meshes of the detection electrodes 131, the meshes of the first driving electrodes 132, and the meshes of the second driving electrodes 152 are described as being formed at the respective edges of the sub-pixels in each pixel in the display device, which will be used after being combined, but the present invention is not limited to this. When the light-shielding member is not disposed at the respective edges of the sub-pixels, for example, the meshes of the detection electrodes 131, the meshes of the first driving electrodes 132, and the meshes of the second driving electrodes 152 are all formed on the color filter at locations in a plan view corresponding to the light-shielding member 12 in a position close to the viewer. Due to this, the viewer will not directly see the detection electrodes 131 and the first driving electrodes 132, and a drop in display quality will be suppressed. “Corresponding in a plan view” means that that the meshes of the detection electrodes 131 and the first driving electrodes 132 and the meshes of the second driving electrodes 152 overlap the light-shielding member 12 as seen from the viewing side, and thus, are formed in a positional relationship that does not stray from the light-shielding member in a plan view.

(Method of Manufacturing Color-Filter Integrated Touch Panel)

Next, a method of manufacturing the color filter-integrated touch panel according to Embodiment 1 of the present invention will be described with reference to FIG. 10. There are no specific descriptions for methods of manufacturing the respective color filter-integrated touch panels described in Embodiments 2 to 3, but one with ordinary skill in the art can conceive of such methods with ease from FIG. 10.

FIGS. 10(a) to 10(f) show respective steps of the method of manufacturing the color filter-integrated touch panel according to Embodiment 1.

First, the color filter glass substrate 11 (hereinafter, described as simply the “substrate” 11) is prepared, and the light-shielding member that functions as a black matrix is formed on this glass substrate. In other words, a resin for forming the light-shielding member is formed on one section, and then unnecessary portions are removed by photolithography to form the mesh-shaped light-shielding member 12 constituted of a plurality of meshes. (See FIG. 10(a))

Next, a metal film for forming the detection electrodes and the first driving electrodes is formed on the substrate 11 on which the light-shielding member 12 is disposed, and the mesh-shaped detection electrodes 131 and the first driving electrodes 132 constituted of a plurality of meshes are formed by photolithography. (See FIG. 10(b))

Next, an insulating film that will be the first insulating layer 14 is formed on the substrate 11, which is where the detection electrodes 131 and the first driving electrodes 132 from FIG. 10(b) are formed. The contact holes 156 for connecting the detection electrode metal bridges and the detection electrodes 131 and the contact holes 157 for connecting the first driving electrodes and the second driving electrodes are formed in this first insulating layer 14 by photolithography. (See FIG. 10(c))

Next, the metal film for forming the second driving electrodes and the detection electrode metal bridges are formed, and the second driving electrodes 152 and the detection electrode metal bridges 155 are formed by photolithography. Although the details are omitted, at this time, the detection electrodes are connected to each other in the Y axis direction by the detection electrode metal bridges through the contact holes 156, and the first driving electrodes 132 and the second driving electrodes 152 are connected to each other through the contact holes 157. (See FIG. 10(d))

Next, the insulating film that will be the second insulating layer 16 is formed, and then the color filter 17 is formed on top of this. Although the details are omitted, the color filter 17 is a made of a layer that has a R, G, or B portion formed in each sub-pixel, for example. (See FIG. 10(e))

Finally, the liquid crystal common electrode 24 for the liquid crystal display device that will be used after being combined is formed. (see FIG. 10(f))

A metal film, such as Ti, a three-layer structure of Ti/Al/Ti, a two-layer structure of Mo/Al, or the like can be suitably used for the detection electrodes, driving electrodes (first driving electrodes and second driving electrodes), and detection electrode metal bridges, for example. The insulating layer can be a JAS interlayer insulating film (permittivity of approximately 3.9) used in general liquid crystal processes, but is more preferably a material with lower permittivity.

To assemble a liquid crystal display device using the “color filter-integrated touch panel” manufactured by the method shown in FIG. 10, this “color filter-integrated touch panel” is adhered to a “another substrate on which liquid crystal driving electrodes and the like are formed” with a gap therebetween for forming the liquid crystal layer.

(Simulation Results)

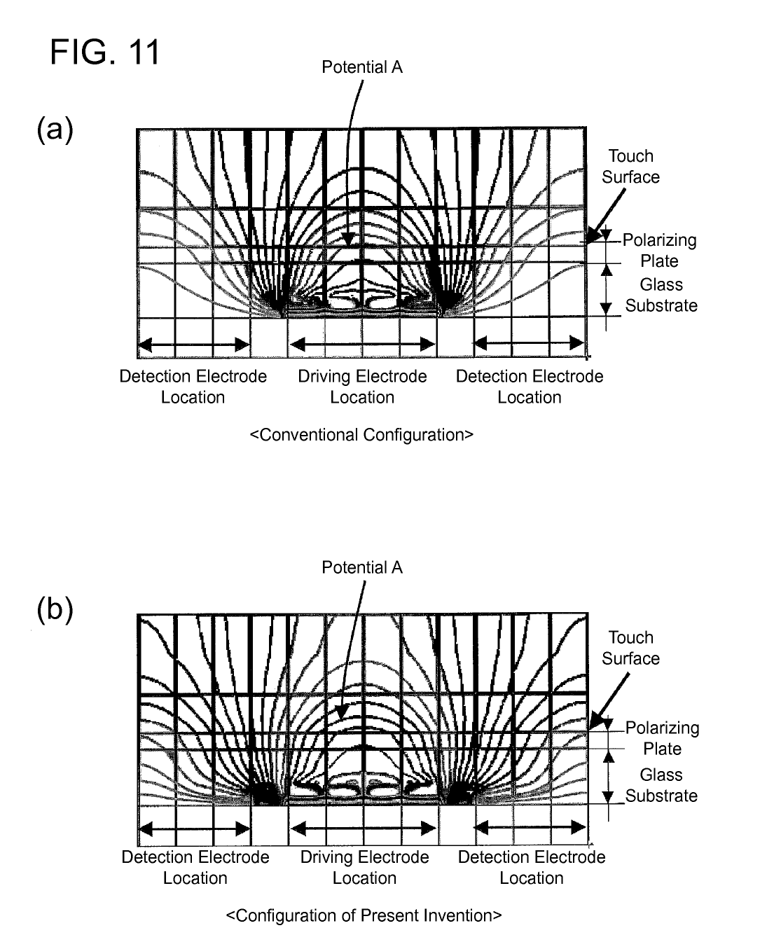

FIG. 11 shows simulation results of the color filter-integrated touch panel of Embodiment 1 according to the present invention.

The results in FIG. 11(a) are from a touch panel component with a conventional structure, or namely, the characteristics of a configuration without the second driving electrodes, whereas the results in FIG. 11(b) are the characteristics of a configuration with the second driving electrodes according to the present invention. FIG. 11 shows a state in which the potential given to the driving electrodes reaches the top of the polarizing plate disposed on top of the glass substrate. In FIGS. 11(a) and 11(b), a given potential A easily exceeds the touch surface in “With Second Driving Electrodes” (see FIG. 11(b)), whereas the given potential A barely reaches the touch surface in “Without Second Driving Electrodes” (conventional configuration) (see FIG. 11(b)). In a capacitive touch panel, the presence or absence of capacitance generated by the difference in potential between the touch surface and the detection electrodes serves as a signal, and thus, the larger the difference is between the touch surface and the detection electrodes (potential: 0), the bigger the touch detection output will become. Accordingly, it is understood that the signal strength obtained by the configuration according to the present invention is superior.

In a conventional touch panel, ΔCf=2.30, whereas in the simulation results, the color filter-integrated touch panel according to Embodiment 1 of the present invention is ΔCf=2.65. The above number, although a qualitative value, is an improvement in signal strength of 1.2 times.

### Embodiment 2

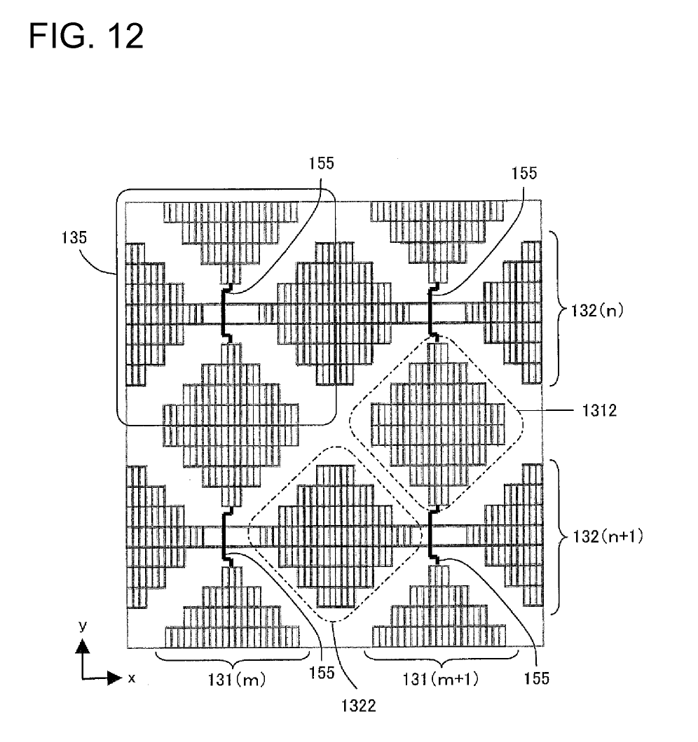

FIGS. 12 to 17 show Embodiment 2 related to a color filter-integrated touch panel of the present invention. In FIGS. 12 to 17, members that are the same as in FIGS. 1 to 9 are given the same reference characters, and detailed explanations thereof will not be repeated. The shape of detection electrodes, driving electrodes (first driving electrodes and second driving electrodes) differ from Embodiment 1, but the materials and the like may be the same. Furthermore, the cross-sectional structure of the color filter-integrated touch panel of Embodiment 2 is the same as the cross-sectional configuration of Embodiment 1 shown in FIG. 3, and a description of the cross-sectional view will be omitted in Embodiment 2.

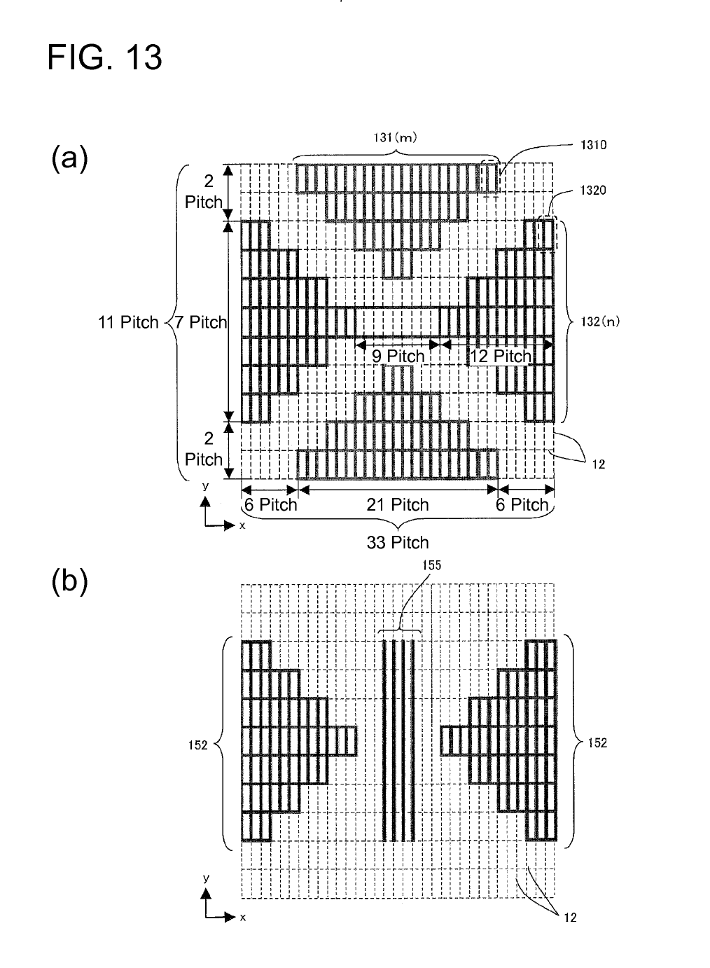

FIGS. 12 and 13 show detection electrodes 131, first driving electrodes 132, second driving electrodes 152, and detection electrode metal bridges 155 of Embodiment 2 of the present invention.

In FIG. 12, two of the detection electrodes 131(m) and 131(m+1) extending in the Y axis direction and two of the first driving electrodes 132(n) and 132(n+1) extending in the X axis direction is described, but in an actual touch panel, a very large number of detection electrodes and first driving electrodes are used depending on the size of the display device, which will be used after being combined. In the explanations below, in a manner similar to Embodiment 1, unless otherwise stated the detection electrodes are simply referred to as “the detection electrodes 131” and in a similar manner the first driving electrodes are simply referred to as “the first driving electrodes 132.”

In FIG. 13, a one node area 135 having the detection electrodes 131, the first driving electrodes 132, the second driving electrodes 152, and the detection electrode metal bridges has been magnified. In a manner similar to Embodiment 1, the detection electrodes 131 and the first driving electrodes 132 are electrically insulated from each other. FIG. 13(a) shows the detection electrodes 131 and the first driving electrodes 132 formed in a first mesh layer 13, and FIG. 13(b) shows the second driving electrodes 152 and the detection electrode metal bridges 155 formed in a second mesh layer 15.

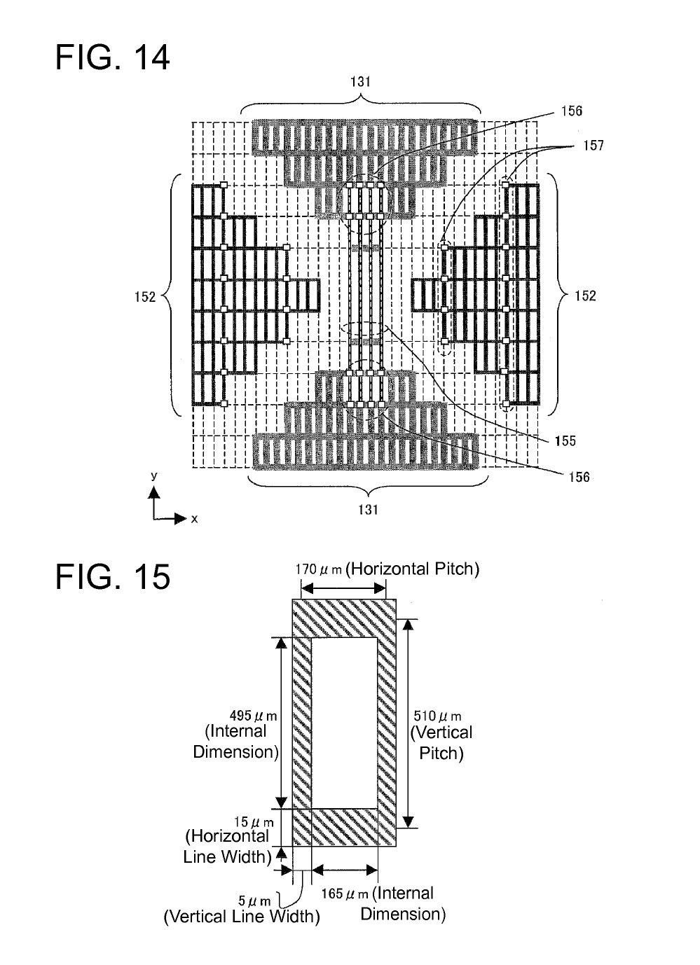

The first driving electrodes 132 are electrically connected in the X axis direction in the first mesh layer 13, but the detection electrodes 131 are not electrically connected in the Y axis direction in the first mesh layer 13. As explained later with reference to FIG. 14, the detection electrodes 131 are electrically connected in the Y axis direction by the detection electrode metal bridges 155 (see FIG. 13(b) and FIG. 14) formed in the second mesh layer 15, in a manner similar to Embodiment 1.

FIG. 13(b) shows the second driving electrodes 152 divided into two sections by the detection electrode metal bridges 155. As is clear from the drawing, the second driving electrodes 152 are formed in positions corresponding to the first driving electrodes 132 in a similar shape. In other words, in Embodiment 2, the second driving electrodes 152 are separated into two at the center of the X axis direction, but the first driving electrodes 132 are electrically connected in the X axis direction.

The second driving electrodes 152 that are separated into two sections are electrically connected to the first driving electrodes 132 disposed in the first mesh layer 13 by through-holes, as will be described later with reference to FIG. 14. Accordingly, this results in the second driving electrodes 152 being electrically connected in the X axis direction, in a manner similar to the first driving electrodes 132.

In Embodiment 2 shown in FIGS. 12 and 13, the detection electrodes 131 are constituted of a plurality of diamond-shaped electrodes 1312 (see FIG. 12), which are themselves constituted by a plurality of meshes 1310 (see FIG. 13) extending in the X axis direction and the Y axis direction. The detection electrodes are electrically connected in the Y axis direction. The driving electrodes 132 are constituted of a plurality of diamond-shaped electrodes 1322 (see FIG. 12), which are themselves constituted of a plurality of meshes 1320 (see FIG. 13) extending in the X axis direction and the Y axis direction. The driving electrodes 132 are electrically connected in the X axis direction.

In FIGS. 13(a) and 13(b), the reference character 12 is a light-shielding member, and in Embodiment 2 the light-shielding member 12, the meshes 1310 of the detection electrodes 131, and the meshes 1320 of the driving electrodes 132 are formed at respective edges of the sub-pixels in the pixels of the display device, which will be used after being combined, in a manner similar to Embodiment 1.

FIG. 14 shows a connection structure in which the detection electrodes 131 are connected by the detection electrode metal bridges 155 and a connection structure in which the first driving electrodes 132 and the second driving electrodes 152 are connected. The detection electrode metal bridges 155 formed in the second mesh layer 15 are electrically connected to the respective detection electrodes 131 formed in the first mesh layer 13 via through-holes disposed on the top and bottom of the detection electrode metal bridges 155 in the drawing. The detection electrodes 131 are electrically connected in the Y axis direction. The first driving electrodes 132 formed in the first mesh layer 13 and the second driving electrodes 152 formed in the second mesh layer 15 are connected to each other via the through-holes 157.

FIG. 15 shows a configuration example of a mesh electrode that constitutes the detection electrodes 131, first driving electrodes, and second driving electrodes in Embodiment 2. The design is the same as Embodiment 1 described with FIG. 7, and a detailed explanation thereof will be omitted.

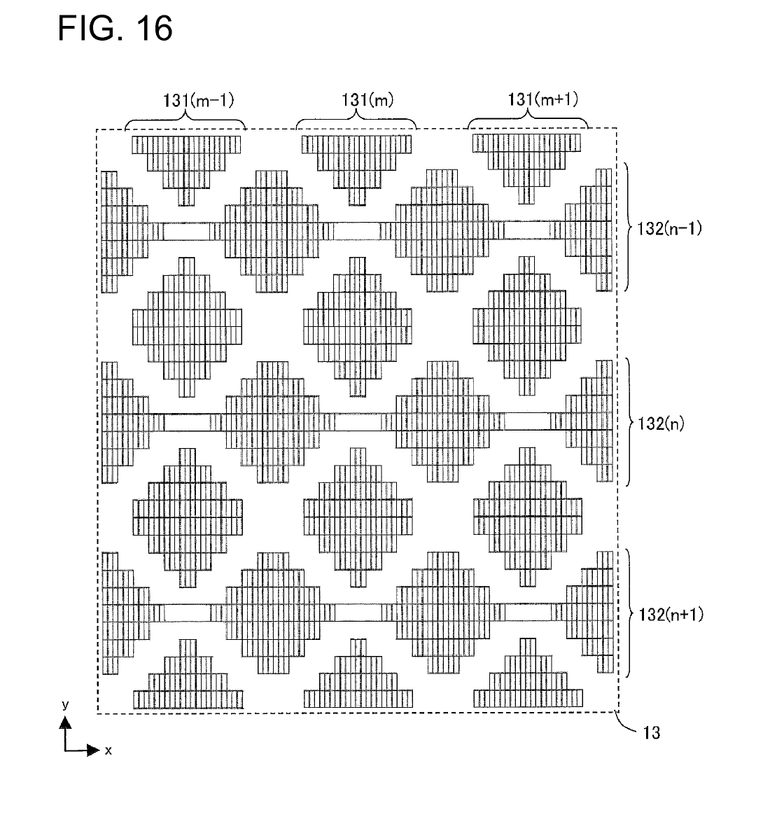

FIG. 16 shows a more practical configuration of the detection electrodes 131 and the first driving electrodes 132 formed in the first mesh layer 13. Namely, three rows of the detection electrodes 131(m−1), 131(m), and 131(m+1) connected in the Y axis direction and three rows of the first driving electrodes 132(n−1), 132(m), and 132(m+1) connected in the X axis direction are shown.

FIG. 17 is a more practical configuration of the second driving electrodes 152 and the detection electrode metal bridges 155 formed in the second mesh layer 15. Namely, three rows of the detection electrode metal bridges 155(m−1), 155(m), and 155(m+1) extending in the Y axis direction and three rows of the second driving electrodes 152(n−1), 152(n), and 152(n+1) extending in the X axis direction are shown. As already described, the detection electrode metal bridges 155 connect the detection electrodes 131 in the Y axis direction via the contact holes 156 (see FIG. 14), and the second driving electrodes 152 are electrically connected to the first driving electrodes 132 via the contact holes 157 (see FIG. 14).

In Embodiment 2, as shown in FIG. 13, the one node area 135 is set at a pitch of 33 in the X axis direction and a pitch of 11 in the Y axis direction, but the size of this one node area 135 in the present invention is not limited to this. The characteristics of the touch panel will change depending on the design values of the various members, and it is not necessarily easy to predict the effects of this in advance, but the design examples in Embodiment 2 achieve very satisfactory results.

### Embodiment 3

FIGS. 18 to 24 show Embodiment 3 related to a color filter-integrated touch panel of the present invention. In FIGS. 18 to 24, members that are the same as in FIGS. 1 to 17 are given the same reference characters, and detailed explanations thereof will not be repeated. In Embodiment 3, the configuration of a second mesh layer 15 differs from Embodiments 1 and 2, but the materials and the like used for detection electrodes, driving electrodes (first driving electrodes and second driving electrodes), detection electrode metal bridges, and the like may be the same as in Embodiments 1 and 2.

FIG. 18 is a cross-sectional view for explaining Embodiment 3, which is related to a color filter-integrated touch panel of the present invention, and shows a liquid crystal display device in which the color filter-integrated touch panel according to Embodiment 3 of the present invention has been integrated with a liquid crystal display component. As already explained, in Embodiment 3 the configuration of the second mesh layer 15 is different from the other embodiments, but this different is not shown in the cross-sectional configuration in FIG. 18.

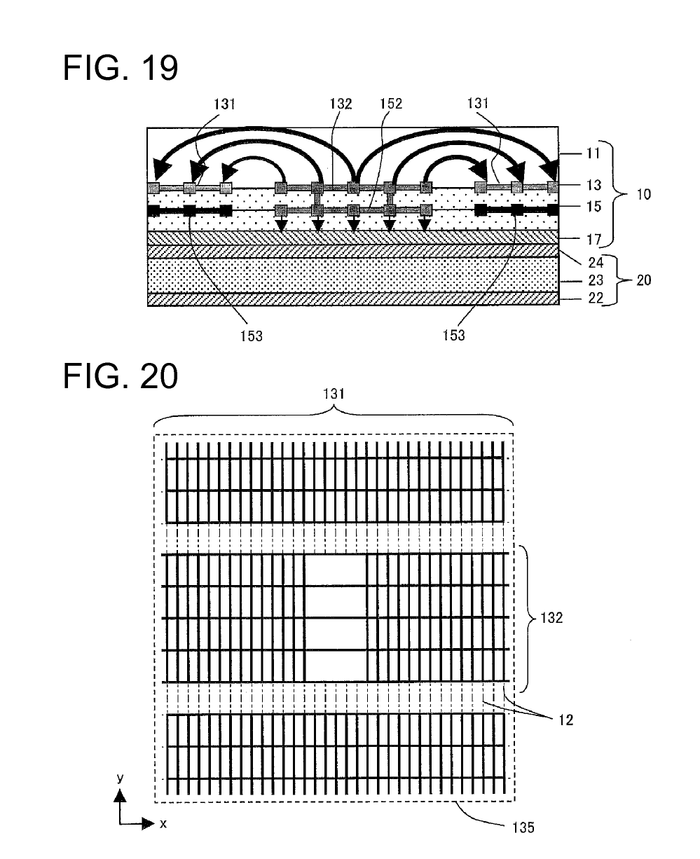

In FIG. 18, reference character 10 shows a color filter-integrated touch panel including a touch panel component 40 and a color filter 17. The touch panel component 40 is a so-called in-cell capacitive touch panel and has a first mesh layer 13, a first insulating layer 14, the second mesh layer 15, and a second insulating layer 16. Detection electrodes 131 and first driving electrodes 132, such as those shown in FIG. 20(a), are formed in the first mesh layer 13 in a manner similar to Embodiment 1.

In Embodiment 3 shown in FIG. 18, in a manner similar to Embodiment 1, the detection electrodes 131 and the driving electrodes 132 are made of a 0.2 μm metal film formed in the first mesh layer 13, and the secondary detection electrodes 152 and the detection electrode metal bridges 155 are made of a 0.2 μm formed in the second mesh layer 15. A Ti film, a three-layer film of Ti/Al/Ti, a two-layer film of Mo/Al, or the like can be used as the metal film, for example. The thickness of a first insulating layer 14 is 2 μm and the thickness of a second insulating layer 16 is 4 μm. In Embodiment 3, ground electrodes 153 disposed in the second mesh layer 15 may be the same metal film of which the second driving electrodes 152 and the like are formed, and are formed at the same time as when the second driving electrodes 152 and the like are formed.

Reference character 20 is the liquid crystal display component, which will be combined with the color filter-integrated touch panel 10 and used. The liquid crystal display component 20 includes a glass substrate 21, a liquid crystal driving electrode 22, a liquid crystal common electrode 24, and a liquid crystal layer 23 filled into the space (gap) between the liquid crystal driving electrode and the liquid crystal common electrode. 30 and 30 are polarizing plates. A liquid crystal display device having a touch panel formed integrally therewith is constituted of the color filter-integrated touch panel 10 including the color filter 17, the liquid crystal display component 20, and the two polarizing plates 30 and 30.

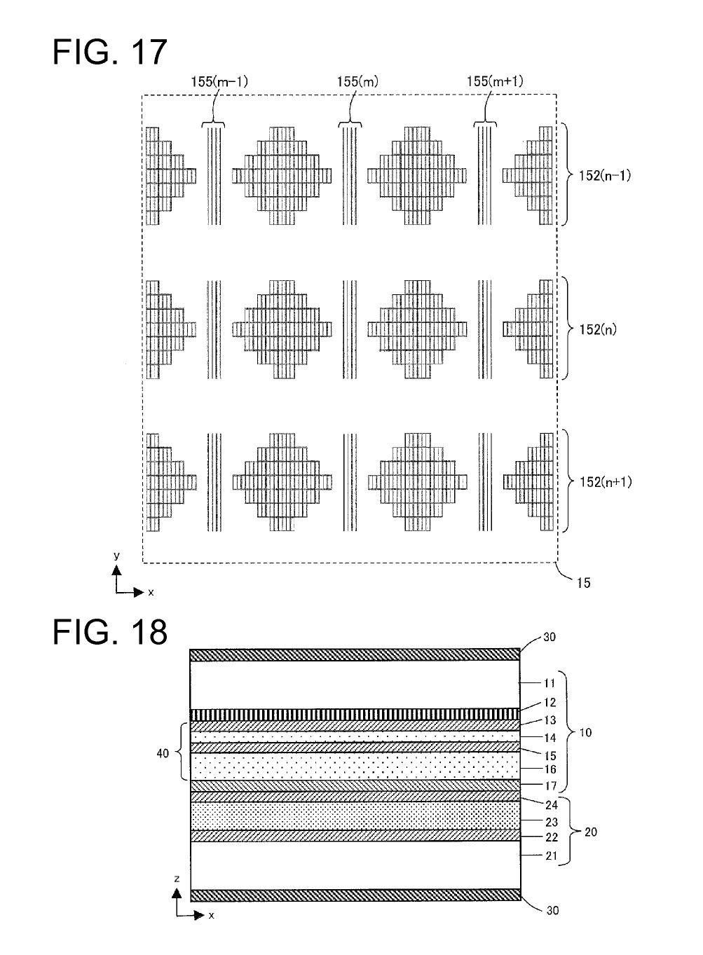

FIG. 19 is a cross-sectional view of the color filter-integrated touch panel according to the present invention shown as to explain the mesh-structure detection electrodes 131, first driving electrodes 132, and second driving electrodes 152. As shown in FIG. 19, the detection electrodes 131 and the first driving electrodes 132 are formed in the first mesh layer 13, and the second driving electrodes 152 are formed in the second mesh layer 15. In Embodiment 3, the ground electrodes 153 are disposed in the second mesh layer 15.

In Embodiment 3 shown in FIG. 19, the second driving electrodes 152 that are electrically connected to the first driving electrodes 132 are formed under the first driving electrodes 132 (as seen from the viewer) formed in the first mesh layer 13, or namely, the side closer to the liquid crystal display component 20. Therefore, as explained with reference to FIG. 2, the second driving electrodes 152 are coupled with liquid crystal common electrode 24 of the liquid crystal display component 20, and as a result, it is possible to increase the electric flux from the first driving electrodes 132 to the touch panel, or namely, the display surface side of a substrate 11, thereby allowing for detection signal strength for touch location detection to be improved.

In Embodiment 3, the mesh-shaped ground electrodes 153 are disposed in the second mesh layer 15 under the detection electrodes 131 formed in the first mesh layer 13. Therefore, the detection electrodes 131 are shielded from unwanted signals from the liquid crystal display component 20 and the like, which allows for stable touch location detection operation.

FIG. 20 shows the electrode configuration of one node area 135 of the first mesh layer 13 in a plan view. In FIG. 20, the reference character 131 is detection electrodes that will be connected in the Y axis direction by the detection electrode metal bridges, described later, and the reference character 132 is first driving electrodes connected in the X axis direction. The configuration of this first mesh layer 13 is the same as the configuration of the first mesh layer 13 of Embodiment 1 described with reference to FIG. 5. The broken line shown by the reference character 12 is a light-shielding member, and the detection electrodes 131 and the first driving electrodes 152 are formed in positions that coincide with this light-shielding member 12 as seen from the viewing side (or namely, as seen in a plan view).

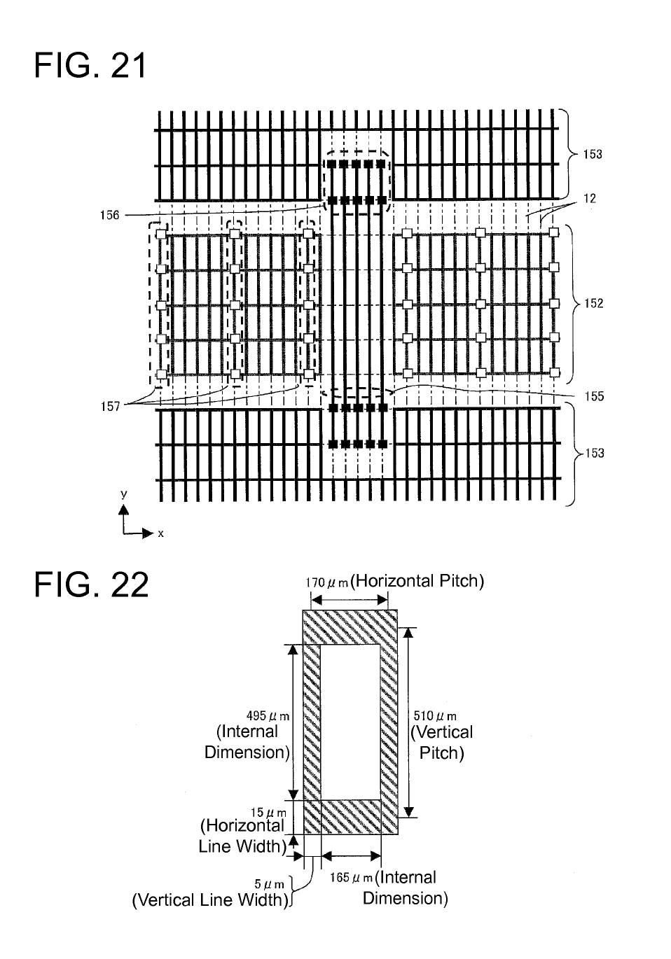

FIG. 21 shows the electrode configuration of the one node area 135 of the second mesh layer 15 in a plan view. The configurations past FIG. 20 have been enlarged so as to be easier to understand, but the actual size of the one node area 135 in these is the same size as the one node area 135 in FIG. 20. One example of a configuration (placement conditions) of through-holes for connecting the first driving electrodes 132 and the second driving electrodes 152 and one example of a configuration (placement conditions) of metal bridges and through-holes for connecting the detection electrodes 131 are shown, and the light-shielding member 12 is shown by the broken line. The second driving electrodes 152, the ground electrodes 153, and the detection electrode metal bridges 155 are formed in positions coinciding with this light-shielding member 12 as seen from the viewing side (or namely, as seen from a plan view).

As is clear from FIG. 21, in Embodiment 3 of the present invention, the second driving electrodes 152 and the detection electrode metal bridges 155 are formed in the second mesh layer 15 along with the ground electrodes 153, which are formed in areas where there are no second driving electrodes 152 or detection electrode metal bridges 155 (in other words, empty sections of the second mesh layer). With this configuration, the ground electrodes 153 cover a large portion of the detection electrodes 131, thereby making it possible to effectively shield the detection electrodes 131 from the liquid crystal display component. Needless to say, the ground electrodes are insulated from the second driving electrodes 152 and the detection electrode metal bridges 155.

FIG. 22 shows a specific design example of one of the meshes constituting the respective detection electrodes 131, first driving electrodes 132, second driving electrodes 152, and ground electrodes 153. This design example is the same as Embodiment 1 described with reference to FIG. 7, and a detailed explanation thereof will be omitted.

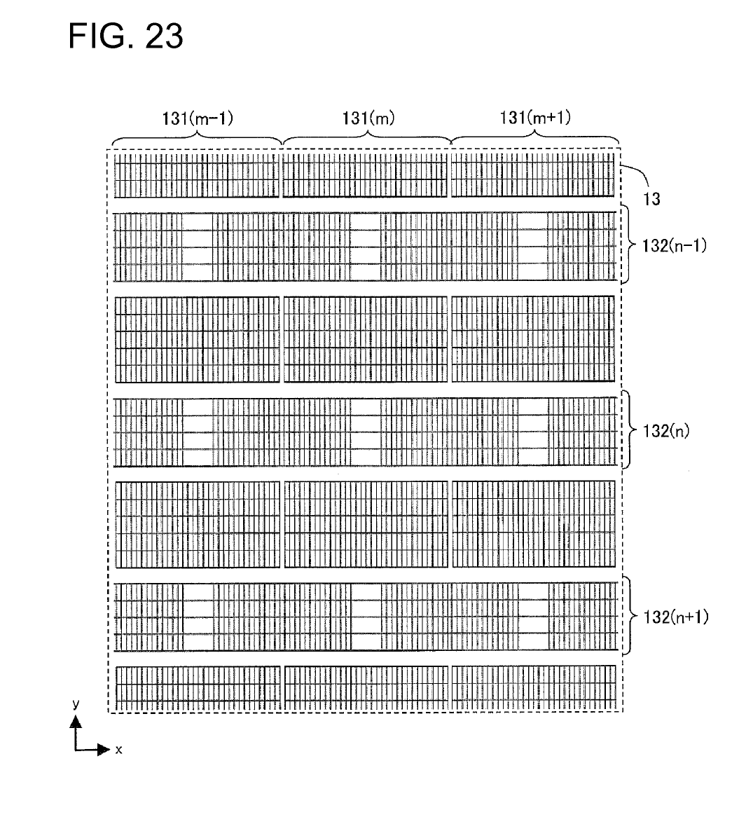

FIG. 23 shows a more practical configuration of the detection electrodes 131 and the first driving electrodes 132 formed in the first mesh layer 13. In other words, three rows of the detection electrodes 131(m−1), 131(m), and 131(m+1) connected in the Y axis direction, and three rows of the first driving electrodes 132(n−1), 132(n), and 132(n+1) connected in the X axis direction are shown.

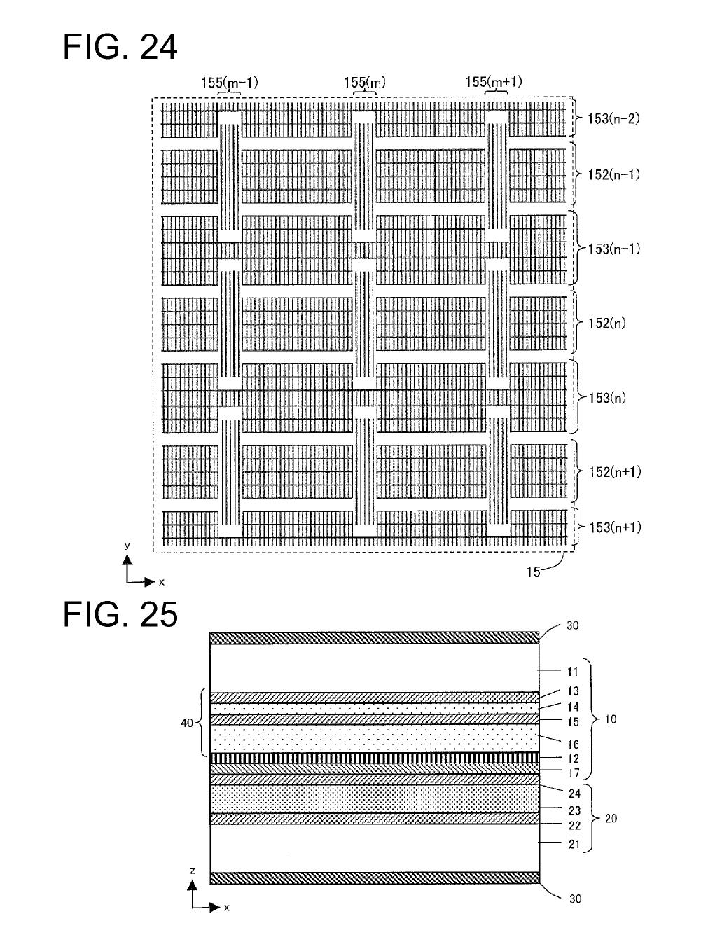

FIG. 24 shows a more practical configuration of the second driving electrodes 152, the detection electrode metal bridges 155, and the ground electrodes 153 formed in the second mesh layer 15. In other words, three rows of the second driving electrodes 152(n−1), 152(n), and 152(n+1) extending in the X axis direction, and the linear detection electrode metal bridges 155(m−1), 155(m), and 155(m+1) extending in the Y axis direction are shown, as well as the ground electrodes 153(n−2), 153(n−1), 153(n), and 153(n+1) extending in the X axis direction. In the present specification, when the ground electrode is not shown at a specific location but is referred to in general, the ground electrode is described as simply “the ground electrodes 153,” in a manner similar to the detection electrodes 131, the first driving electrodes 132, and the like.

As is clear from FIG. 24, the ground electrodes 153 are formed in the second mesh layer 15 in areas where the second driving electrodes 153 and the detection electrode metal bridges 155 are not formed, or namely, in empty sections of the second mesh layer 15. Although not shown in FIG. 24, the ground electrodes 153 are grounded by the ends thereof, for example, at the appropriate areas.

In Embodiment 3 described above, the shapes of the detection electrodes 131, the first driving electrodes 132, and the secondary detection electrodes 152 are described as rectangular, in a manner similar to Embodiment 1, but the present invention is not limited to this. The respective electrodes may be a plurality of diamond-shaped electrodes that are electrically connected, as shown in Embodiment 2, for example. In this case, the ground electrodes 152 that will be formed in the second mesh layer are formed in areas where the second driving electrodes 152 and the detection electrode metal bridges 155 are not formed, or in other words, in empty areas.

### Embodiment 4

FIG. 25 shows Embodiment 4 related to a color filter-integrated touch panel of the present invention. In FIG. 25, members that are the same as in FIGS. 1 to 24 are given the same reference characters, and a detailed description of these members will not be repeated. The location of a light-shielding member 12 in Embodiment 4 differs from Embodiments 1, 2, and 3, but the configurations of the other members may be the same.

In Embodiments 1 to 3, the light-shielding member 12 was formed to the closest position to the viewing side, or namely, on the color filter glass substrate 11. In Embodiment 4, however, the light-shielding member 12 is on a touch panel component 40 and disposed close to a liquid crystal display component 20 that will be used after being combined. More specifically, as shown in FIG. 25, in Embodiment 4 the light-shielding member 12 is formed between the touch panel component 40 and a color filter 17. In this case, the light-shielding member 12 is formed at respective edges of sub-pixels in the display device in question, which is similar to Embodiments 1, 2, and 3. The configurations shown in Embodiments 1 to 3 can be adopted for everything else besides “the location of the light-shielding member 12,” but a specific detailed explanation thereof will be omitted.

With this configuration, the distance between the touch panel component 40 and a liquid crystal common electrode 24 of the liquid crystal display component 20 becomes greater, which can more efficiently block signal degradation and prompt further improvement in detection sensitivity of touch location detection.

### Embodiment 5

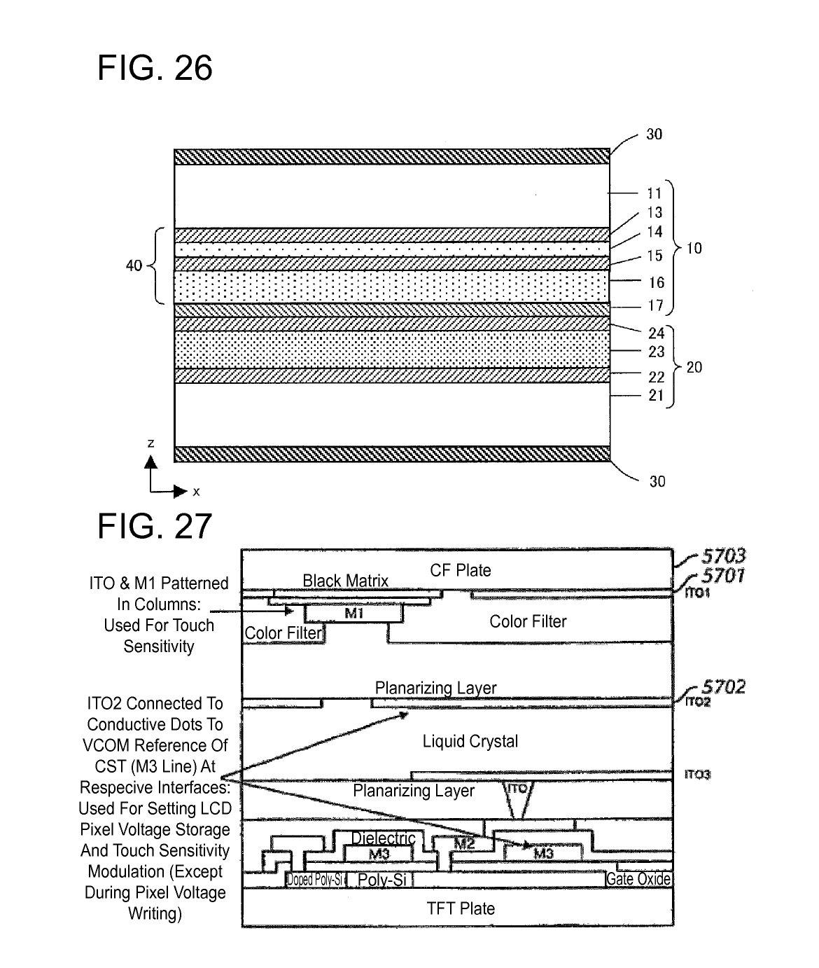

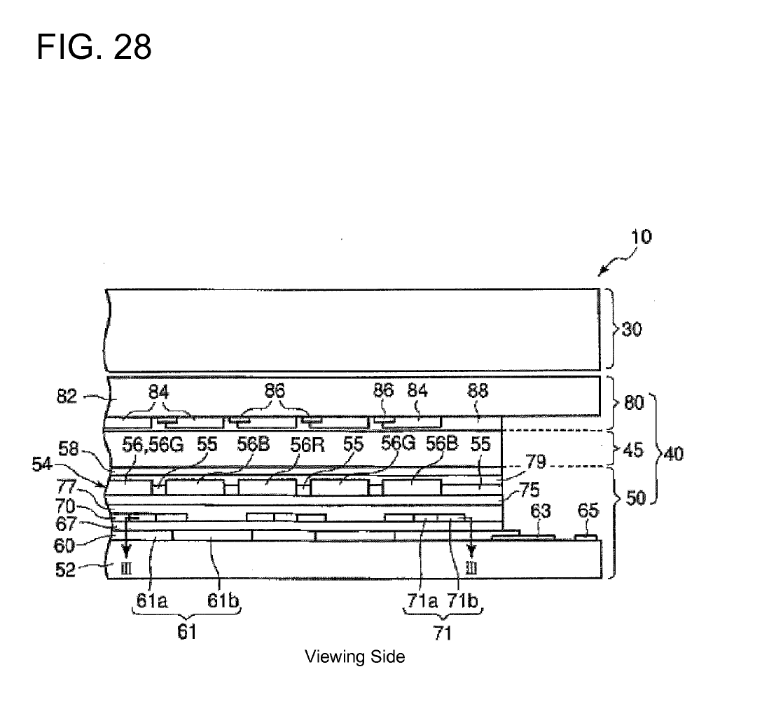

FIG. 26 shows Embodiment 5 related to a color filter-integrated touch panel of the present invention. In FIG. 26, members that are the same as in FIGS. 1 to 25 are given the same reference characters, and a detailed description of these members will not be repeated. Embodiment 5 differs from Embodiments 1 to 4 in that a light-shielding member 12 is omitted, but configurations of other members may be the same as in Embodiments 1 to 4.

In Embodiment 5, the light-shielding member 12 has been omitted from the color filter-integrated touch panel shown in Embodiments 1 to 4. A function similar to that of a light-shielding member, or black matrix, is given to detection electrodes 131 and first driving electrodes 132 disposed in a first mesh layer 13 and second driving electrodes 152 and detection electrode metal bridges 155 disposed in a second mesh layer 15. In this case, areas where electrodes are not disposed when viewing the first mesh layer 13 and the second mesh layer 15 in a plan view are configured to have a pitch of one or less. In other words, the gaps (the gaps of areas that have no electrodes) when viewing the first mesh layer 13 and the second mesh layer 15 in a plan view is set at a pitch of one or less. “A pitch of one or less” means that gaps between the respective electrodes with a pitch of 0.9 may be used, for example. As already described, the width of one pitch in the X axis direction differs from the width of one pitch in the Y axis direction, and accordingly, when there is an “gap of one pitch,” the actual distance will differ between the X axis direction and the Y axis direction.

In Embodiment 3 as described with reference to FIGS. 20 to 24, the gaps (the area where electrodes are not disposed) can be formed at one pitch or less with ease due to the second driving electrodes 152, the ground electrodes 153, and the detection electrode metal bridges 155 formed in the second mesh layer 15. In this case, however, it is necessary for the second driving electrodes, the detection electrode metal bridges, and the ground electrodes to be insulated from each other in the second mesh layer 15. In order for the second driving electrodes 152, the ground electrodes 153, and the detection electrode metal bridges 155 formed in the second mesh layer 15 to double as a light-shielding member and have a black matrix function, it is preferable that a conductive material with a high light-shielding effect be used for these electrodes, such as metallic chromium, titanium, nickel, or the like.

The inventors of the present invention have confirmed that forming the floating electrodes 151, the second driving electrodes 152, the ground electrodes 153, and the detection electrode metal bridges 155 with respective gaps therebetween of one pitch or less is sufficient for these electrodes to have a black matrix function.

Even if the display device is formed by using the color filter-integrated touch panel having this configuration, a display quality that in practice has no particular short-comings can be achieved. According to Embodiment 5, it is not necessary to have a separately provided light-shielding member functioning as black matrix, thereby simplifying the process of manufacturing the color filter-integrated touch panel. Due to this, fewer materials are required, and costs can be suppressed. In other words, even if the light-shielding member is omitted, the second driving electrodes, the ground electrodes, and the detection electrode metal bridges that have all had the separation distance therebetween minimized can have a function similar to a black matrix, which makes it possible to reduce costs while providing a color filter-integrated touch panel that is suitable for a large-screen display device.

### INDUSTRIAL APPLICABILITY

The present invention provides a color filter-integrated touch panel with a large surface area, can be applied to the entire surface of a large-screen display device, and can minimize degradation of display quality. The present invention has high industrial applicability.

### DESCRIPTION OF REFERENCE CHARACTERS

10 color filter-integrated touch panel
11 CF (color filter) glass substrate
12 light-shielding member (black matrix)
13 first mesh layer
130 driving electrode
131 detection electrode
1310 mesh of detection electrode
1311 rectangular electrode constituted of a plurality of meshes (detection electrode)
1312 diamond-shaped electrode constituted of a plurality of meshes (detection electrode)
132 primary driving electrode
1320 mesh of driving electrode (primary driving electrode and secondary driving electrode)
1321 rectangular electrode constituted of a plurality of meshes (detection electrode)
1322 diamond-shaped electrode constituted of a plurality of meshes (detection electrode)
135 one node area
14 first insulating layer
15 second mesh layer
152 secondary driving electrode
153 ground electrode
155 detection electrode metal bridge
156 contact hole (for detection electrode)
157 contact hole (for driving electrode)
16 second insulating layer
17 color filter
20 liquid crystal display component
21 glass substrate
22 liquid crystal driving electrode
23 liquid crystal layer
24 liquid crystal common electrode
30 polarizing plate
40 touch panel component

1. A color filter-integrated touch panel, comprising:
a substrate;
a touch panel component having detection electrodes and driving electrodes for touch location detection disposed on the substrate; and
a color filter formed on the touch panel component,
wherein the detection electrodes and the driving electrodes of the touch panel component are insulated from each other and are each mesh-shaped electrodes formed of a plurality of meshes,
wherein the detection electrodes of the touch panel component are formed in a first mesh layer between the substrate and the color filter,
wherein the driving electrodes comprise first driving electrodes formed in the first mesh layer and second driving electrodes formed in a second mesh layer that is between the first mesh layer and the color filter, and
wherein at least a portion of the first driving electrodes and the second driving electrodes are formed in locations overlapping each other, said first driving electrodes and said second driving electrodes being connected to each other.

2. The color filter-integrated touch panel according to claim 1, further comprising:
a light-shielding member formed on the substrate that is adjacent to a viewing side,
wherein the meshes of the detection electrodes and the driving electrodes forming the touch panel component are disposed at locations corresponding to said light-shielding member in a plan view.

3. The color filter-integrated touch panel according to claim 2,
wherein the light-shielding member is formed at respective edges of sub-pixels, and
wherein the meshes of the detection electrodes, the first driving electrodes, and the second driving electrodes forming the touch panel component are disposed at respective edges of the sub-pixels.

4. The color filter-integrated touch panel according to claim 1, wherein the detection electrodes and the driving electrodes of the touch panel component are made of a metal film.

5. The color filter-integrated touch panel according to claim 1,
wherein the detection electrodes are rectangular electrodes constituted of the plurality of meshes that extend in an X axis direction and a Y axis direction, a plurality of said detection electrodes being electrically connected in the Y axis direction, and
wherein the first driving electrodes and the second driving electrodes forming the driving electrodes are rectangular electrodes constituted of the plurality of meshes that extend in the X axis direction and the Y axis direction, a plurality of said driving electrodes being electrically connected in the X axis direction.

6. The color filter-integrated touch panel according claim 1,
wherein the detection electrodes are diamond-shaped electrodes constituted of the plurality of meshes that extend in an X axis direction and a Y axis direction, a plurality of said detection electrodes being electrically connected in the Y axis direction, and
wherein the first driving electrodes and the second driving electrodes forming the driving electrodes are diamond-shaped electrodes constituted of the plurality of meshes that extend in the X axis direction and the Y axis direction, a plurality of said driving electrodes being electrically connected in the X axis direction.

7. The color filter-integrated touch panel according to claim 1, further comprising:
second driving electrodes and detection electrode metal bridges disposed in the second mesh layer, said detection electrode metal bridges connecting the detection electrodes to each other; and
ground electrodes disposed in empty areas of the second mesh layer.

8. The color filter-integrated touch panel according to claim 2,
wherein the touch panel component having the detection electrodes and the driving electrodes is formed on the light-shielding member.

9. The color filter-integrated touch panel according to claim 2, further comprising:
a display component formed on the touch panel component,
wherein the touch panel component having the detection electrodes and the driving electrodes is formed on the substrate, and
wherein the light-shielding member is formed at a location adjacent to the display component.

10. The color filter-integrated touch panel according to claim 1, further comprising:
detection electrode metal bridges and ground electrodes formed in the second mesh layer along with the second driving electrodes, said detection electrode metal bridges connecting the detection electrodes to each other,
wherein the second driving electrodes, the detection electrode metal bridges, and the ground electrodes in the second mesh layer are insulated from each other and have gaps therebetween of one pitch or less, and
wherein the second driving electrodes, the detection electrode metal bridges, and the ground electrodes have a light-shielding function.

11. The color filter-integrated touch panel according to claim 1, further comprising:
a third mesh layer disposed between the second mesh layer and the color filter across insulating layers; and
third driving electrodes disposed at a location where at least a portion thereof overlaps the first driving electrodes and the second driving electrodes, said third driving electrodes being electrically connected to the first driving electrodes and the second driving electrodes.

12. A liquid crystal display device, comprising:
the color filter-integrated touch panel according to claim 1.

13. A plasma display device, comprising:
the color filter-integrated touch panel according to claim 1.

14. An electroluminescent display device, comprising:
the color filter-integrated touch panel according to claim 1.
